(19) United States
(12) Patent Application Publication
(10) Pub. No.: US 2022/0245792 A1
(43) Pub. Date: Aug. 4, 2022

(54) SYSTEMS AND METHODS FOR IMAGE QUALITY DETECTION

(71) Applicant: BEIJING DIDI INFINITY TECHNOLOGY AND DEVELOPMENT CO., LTD., Beijing (CN)

(72) Inventors: Haitao GAO, Beijing (CN); Yifei ZHANG, Beijing (CN); Guozhen LI, Beijing (CN); Youzeng LI, Beijing (CN); Zhangxi YAN, Beijing (CN); Peilun LI, Hangzhou (CN)

(73) Assignee: BEIJING DIDI INFINITY TECHNOLOGY AND DEVELOPMENT CO., LTD., Beijing (CN)

(21) Appl. No.: 17/658,819

(22) Filed: Apr. 11, 2022

Related U.S. Application Data
(63) Continuation of application No. PCT/CN2019/110515, filed on Oct. 11, 2019.

(51) Int. Cl. G06T 7/00; G06V 10/422; G06V 10/82

(52) U.S. Cl. CPC G06T 7/0008; G06V 10/422; G06T 2207/30168; G06T 2207/20081; G06T 2207/20084; G06V 10/82

(57) ABSTRACT

The disclosure relates to system and method for image quality detection. The method may include: obtaining an image acquired by a camera; obtaining an image quality detection model, the image quality detection model being provided by training a machine learning model using a plurality of training samples; determining a detection result of the image using the image quality detection model; and in response to a determination that the detection result includes a quality anomaly of the image, generating a strategy in response to the quality anomaly.

### CROSS-REFERENCE TO RELATED APPLICATIONS

This application is a continuation of International Application No. PCT/CN2019/110515, filed on Oct. 11, 2019, the entire content of which is incorporated herein by reference.

### TECHNICAL FIELD

The present disclosure generally relates to systems and methods for image processing technology, and in particular, to systems and methods for image quality detection.

### BACKGROUND

Cameras are widely mounted on a vehicle for video surveillance. For example, a camera may be mounted inside a vehicle for monitoring an area outside of the vehicle which may provide real-time road information (e.g., the location of a parking area, traffic congestion). As another example, with the popularization of online to offline services (e.g., a transporting service), a vehicle for providing the transporting service may be installed with a camera for monitoring an area inside of the vehicle, especially for monitoring various dangerous situations occurring during the transport service, for example, drivers' dangerous driving behaviors, drivers' jeopardizing of passengers' personal safety or property safety, unexpected traffic accidents, robbery of drivers by the passenger, etc. However, various anomalies may happen to the camera, causing the camera not to be capable of capturing a qualified image, thus providing useful information. Therefore, it is desirable to provide systems and methods for efficiently detecting image quality and/or the state of the camera.

### SUMMARY

In a first aspect of the present disclosure, a system for image quality detection is provided. The system may include at least one storage medium and at least one processor. The at least one storage medium may include a set of instructions. The at least one processor may be in communication with the at least one storage medium, wherein when executing the set of instructions, the at least one processor may be directed to cause the system to perform one or more of the following operations. The at least one processor may obtain an image acquired by a camera. The at least one processor may obtain an image quality detection model. The image quality detection model may be provided by training a machine learning model using a plurality of training samples. The at least one processor may determine a detection result of the image using the image quality detection model. In response to a determination that the detection result includes a quality anomaly of the image, the at least one processor may generate a strategy in response to the quality anomaly.

In some embodiments, the quality anomaly of the image may include at least one of a blocking anomaly, a blur anomaly, an angle anomaly, a color cast anomaly, or a fill light anomaly.

In some embodiments, the image quality detection model may be constructed based on a plurality of sub-models, each of at least a portion of the plurality of sub-models being configured to detect one of the blocking anomaly, the blur anomaly, the angle anomaly, the color cast anomaly, or the fill light anomaly.

In some embodiments, the image quality detection model may be constructed based on at least one of a neural network model, a regression model, or a support vector machine.

In some embodiments, to determine the detection result of the image using the image quality detection model, the at least one processor may extract one or more features from the image. The at least one processor may determine, based on the one or more features, the detection result using the image quality detection model.

In some embodiments, to extract one or more features from the image, the at least one processor may mark a reference object in the image. The at least one processor may extract the one or more features associated with the reference object using the image quality detection model. To determine, based on the one or more features, the detection result using the image quality detection model, the at least one processor may determine, based on the one or more features associated with the reference object, a relative location of the reference object in the image using the image quality detection model. The at least one processor may further determine, based on the relative location of the reference object in the image, the detection result.

In some embodiments, the reference object may include at least one of a skyline or a component of a vehicle installed with the camera, the component of the vehicle including at least one of an A-pillar, a B-pillar, or a neck pillow.

In some embodiments, to extract one or more features from the image, the at least one processor may further determine the one or more features associated with pixels in the image using the image quality detection model. To determine, based on the one or more features, the detection result using the image quality detection model, the at least one processor may determine, based on the one or more features associated with the pixels in the image, the detection result using the image quality detection model

In some embodiments, the one or more features associated with the pixels in the image may include at least one of a gradient feature or a histogram feature.

In some embodiments, to provide the image quality detection model, the at least one processor may label each of the plurality of training samples with a reference label. The at least one processor may train the machine learning model to obtain the image quality detection models using the plurality of training samples and the reference label corresponding to each of the plurality of training samples.

In some embodiments, the reference label may indicate that the each of the plurality of training samples has a quality anomaly or a normal quality. To train the machine learning model to obtain the image quality detection models, the at least one processor may extract one or more features associated with pixels in the each of the labeled training samples. The at least one processor may train the machine learning model to obtain the image quality detection models using the one or more features associated with pixels in the each of the labeled training samples and the reference label of the each of the plurality of training samples.

In some embodiments, to label each of the plurality of training samples with the reference label, the at least one processor may determine a location of a reference subject in each of the plurality of training samples. The at least one processor may determine, based on the location of the reference subject in each of the plurality of training samples, the reference label. To train the machine learning model to obtain the image quality detection models using the labeled training samples, the at least one processor may input the each of the plurality of training samples and the corresponding reference label into the machine learning model to train the machine learning model.

In some embodiments, to provide the plurality of training samples, the at least one processor may obtain one or more clear images. The at least one processor may perform a blur operation on the each of the one or more clear images to obtain a blurred image corresponding to each of the one or more clear images. The at least one processor may determine one or more features of the blurred image. The at least one processor may designate the blurred image as one of at least a portion of the plurality of training samples in response to a determination that the one or more features of the blurred image satisfy a condition.

In some embodiments, to provide the plurality of training samples, the at least one processor may obtain one or more second reference images. The at least one processor may convert each of the one or more second reference images from an RPG space into an HSV space. The at least one processor may determine one or more average features of the one or more second reference images in the HSV space. The at least one processor may obtain, based on the one or more average features, a plurality of candidate images. The at least one processor may determine one or more specific cameras whose light are in breakdown. The at least one processor may obtain at least a portion of the plurality of training samples from the one or more specific cameras.

In some embodiments, to determine the detection result of the image using the image quality detection model, the at least one processor may determine a coincidence level corresponding to each of at least a portion of one or more quality anomalies using the image quality detection model. The at least one processor may determine, based on the coincidence level corresponding to each of at least a portion of the one or more quality anomalies, the detection result.

In a second aspect of the present disclosure, a system for image quality detection is provided. The system may include at least one storage medium and at least one processor. The at least one storage medium may include a set of instructions. The at least one processor may be in communication with the at least one storage medium, wherein when executing the set of instructions, the at least one processor may be directed to cause the system to perform one or more of the following operations. The at least one processor may obtain an image acquired by a camera. The at least one processor may determine, based on a target threshold of an image quality detection model, a detection result of the image using the image quality detection model. The at least one processor may, in response to a determination that the detection result includes a color cast anomaly, generate a strategy in response to the color cast anomaly. To provide the target threshold, the at least one processor may obtain a plurality of samples, each of at least a portion of the plurality of samples having a reference label indicating that each of the at least a portion of the plurality of samples having a color cast anomaly. The at least one processor may determine, based on the plurality of samples, the target threshold of the image quality detection model.

In some embodiments, to determine, based on the plurality of samples, the target threshold for image color cast detection, the at least one processor may convert each of the plurality of samples from an RGB space into a LAB space. The at least one processor may determine an average chromaticity of each of the plurality of samples in the LAB space. The at least one processor may determine, based on the average chromaticity, a color cast factor of each of the plurality of samples. The at least one processor may determine, based on the color cast factor of each of the plurality of samples, the target threshold.

In some embodiments, to determine, based on the average chromaticity, the color cast factor of each of the plurality of samples, the at least one processor may determine a color center distance for each of the plurality of samples. The at least one processor may determine, based on the average chromaticity and the color center distance, the color cast factor of each of the plurality of samples

In some embodiments, to determine, based on the color cast factor of each of the plurality of samples, the target threshold, the at least one processor may determine, based on color cast factors corresponding to at least a portion of the plurality of samples, a plurality of candidate thresholds of the image quality detection model. The at least one processor may determine an evaluation result by evaluating the image quality detection model with respect to each of the plurality of candidate thresholds. The at least one processor may determine, based on the evaluation result, the target threshold from the plurality of candidate thresholds.

In some embodiments, to determine the evaluation result by evaluating each of the plurality of candidate thresholds, the at least one processor may, for each of the plurality of candidate thresholds, determine, using the image quality detection model with respect to each of the plurality of candidate thresholds, an estimated label of each of the plurality of samples. The at least one processor may determine, based on the estimated label and the reference label of each of the plurality of samples, an evaluation index of the image quality detection model with respect to each of the plurality of candidate thresholds. The at least one processor may determine, based on the evaluation index of the image quality detection model with respect to each of the plurality of candidate thresholds, the target threshold. The evaluation index may be associated with a confusion matrix for the image quality detection model.

In some embodiments, to determine, based on the evaluation index of the image quality detection model with respect to each of the plurality of candidate thresholds, the target threshold, the at least one processor may identify, from the plurality of candidate thresholds, a candidate threshold that corresponds to a maximum of the evaluation index. The at least one processor may designate the identified candidate threshold as the target threshold associated with the image quality detection model.

In a third aspect of the present disclosure, a system for image quality detection is provided. The system may include at least one storage medium and at least one processor. The at least one storage medium may include a set of instructions. The at least one processor may be in communication with the at least one storage medium, wherein when executing the set of instructions, the at least one processor may be directed to cause the system to perform one or more of the following operations. The at least one processor may obtain one or more target template images presenting one or more spots. The at least one processor may obtain an image acquired by a camera. The at least one processor may determine, based on the one or more target template images, a detection result of the image. The at least one processor may, in response to a determination that the detection result includes a spot anomaly, generate a strategy in response to the spot anomaly.

In some embodiments, to provide the one or more template images, the at least one processor may obtain a plurality of samples, each of the plurality of samples having a reference label indicating whether each of the plurality of samples includes the spot anomaly. The at least one processor may classify at least a portion of the plurality of samples into several groups, each of the at least a portion of the plurality of samples in the several groups presenting the one or more spots. The at least one processor may determine a candidate template images from samples in each of the several groups to obtain multiple candidate template images. The at least one processor may evaluate, based on the plurality of samples, the multiple candidate template images to determine an evaluating result. The at least one processor may determine, based on the evaluating result, the one or more target template images.

In some embodiments, to evaluate, based on the plurality of samples, the multiple candidate template images to determine an evaluating result, the at least one processor may determine, based on the multiple candidate template images, an estimated label of each of the plurality of samples. The at least one processor may determine, based on the estimated label and the reference label of each of the plurality of samples, an evaluation index. The at least one processor may determine, based on the evaluation index, the one or more target template images, wherein the evaluation index is associated with a confusion matrix.

In some embodiments, to determine, based on the multiple candidate template images, the estimated label of each of the plurality of samples, the at least one processor may, for each of the multiple candidate template images, determine a similarity degree between the each of the multiple candidate template images and each of the plurality of samples. The at least one processor may determine, based on the similarity degree, the estimated label of each of the plurality of samples.

In some embodiments, to determine, based on the evaluation index, the one or more target template images, the at least one processor may determine the multiple candidate template images as the one or more target template images in response to a determination that the evaluation index satisfies a condition.

In some embodiments, to determine, based on the one or more target template images, the detection result of the image, the at least one processor may determine the detection result of the image by performing a template matching algorithm between the each of the one or more target template images and the image.

In some embodiments, to determine the detection result of the image by performing a template matching algorithm between each of the one or more target template images and the image, the at least one processor may determine a matching coefficient between the image and each of the one or more target templates. The at least one processor may determine, based on the matching coefficient between the image and each of the one or more target templates, the detection result.

In a fourth aspect of the present disclosure, a method for image quality detection is provided. The method may be implemented on a computing device having at least one processor, at least one storage medium and a communication platform connected to a network. The method may include one or more of the following operations. The at least one processor may obtain an image acquired by a camera. The at least one processor may obtain an image quality detection model, the image quality detection model being provided by training a machine learning model using a plurality of training samples. The at least one processor may determine a detection result of the image using the image quality detection model. The at least one processor may, in response to a determination that the detection result includes a quality anomaly of the image, generate a strategy in response to the quality anomaly.

In a fifth aspect of the present disclosure, a method for image quality detection is provided. The method may be implemented on a computing device having at least one processor, at least one storage medium and a communication platform connected to a network. The method may include one or more of the following operations. The at least one processor may determine, based on a target threshold of an image quality detection model, a detection result of the image using the image quality detection model. In response to a determination that the detection result includes a color cast anomaly, the at least one processor may generating a strategy in response to the color cast anomaly. The target threshold may be provided by obtaining a plurality of samples, each of at least a portion of the plurality of samples having a reference label indicating that each of the at least a portion of the plurality of samples having a color cast anomaly, and determining, based on the plurality of samples, the target threshold of the image quality detection model.

In a sixth aspect of the present disclosure, a method for image quality detection is provided. The method may be implemented on a computing device having at least one processor, at least one storage medium and a communication platform connected to a network. The method may include one or more of the following operations. The at least one processor may obtain one or more target template images presenting one or more spots. The at least one processor may obtain an image acquired by a camera. The at least one processor may determine, based on the one or more target template images, a detection result of the image. The at least one processor may, in response to a determination that the detection result includes a spot anomaly, generate a strategy in response to the spot anomaly.

In a seventh aspect of the present disclose, a non-transitory computer readable medium is provided. The non-transitory computer readable medium may include at least one set of instructions for image quality detection that, when executed by at least one processor, direct the at least one processor to perform a method. The method may include one or more of the following operations. The at least one processor may obtain an image acquired by a camera. The at least one processor may obtain an image quality detection model, the image quality detection model being provided by training a machine learning model using a plurality of training samples. The at least one processor may determine a detection result of the image using the image quality detection model. The at least one processor may, in response to a determination that the detection result includes a quality anomaly of the image, generate a strategy in response to the quality anomaly.

In an eighth aspect of the present disclose, a non-transitory computer readable medium is provided. The non-transitory computer readable medium may include at least one set of instructions for image quality detection that, when executed by at least one processor, direct the at least one processor to perform a method. The method may include one or more of the following operations. The at least one processor may determine, based on a target threshold of an image quality detection model, a detection result of the image using the image quality detection model. In response to a determination that the detection result includes a color cast anomaly, the at least one processor may generating a strategy in response to the color cast anomaly. The target threshold may be provided by obtaining a plurality of samples, each of at least a portion of the plurality of samples having a reference label indicating that each of the at least a portion of the plurality of samples having a color cast anomaly, and determining, based on the plurality of samples, the target threshold of the image quality detection model.

In a ninth aspect of the present disclose, a non-transitory computer readable medium is provided. The non-transitory computer readable medium may include at least one set of instructions for image quality detection that, when executed by at least one processor, direct the at least one processor to perform a method. The method may include one or more of the following operations. The at least one processor may obtain one or more target template images presenting one or more spots. The at least one processor may obtain an image acquired by a camera. The at least one processor may determine, based on the one or more target template images, a detection result of the image. The at least one processor may, in response to a determination that the detection result includes a spot anomaly, generate a strategy in response to the spot anomaly.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary O2O service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4A is a block diagram illustrating an exemplary processing device according to some embodiments of the present disclosure;

FIG. 4B is a block diagram illustrating an exemplary processing device according to some embodiments of the present disclosure

FIG. 5 is a flowchart illustrating an exemplary process for detecting an image quality according to some embodiments of the present disclosure;

FIG. 6 is a flowchart illustrating an exemplary process for determining a detection result of an image according to some embodiments of the present disclosure;

FIG. 7 is a flowchart illustrating an exemplary process for training an image anomaly detection model for detecting an angle anomaly according to some embodiments of the present disclosure;

FIG. 8 is a flowchart illustrating an exemplary process for performing an image quality detection according to some embodiments of the present disclosure;

FIG. 9 is a flowchart illustrating an exemplary process for training an image anomaly detection model according to some embodiments of the present disclosure;

FIG. 10 is a flowchart illustrating an exemplary process for determining a plurality of training samples according to some embodiments of the present disclosure;

FIG. 11 is a flowchart illustrating an exemplary process for determining a plurality of training samples according to some embodiments of the present disclosure;

FIG. 12 is a flowchart illustrating an exemplary process for determining a detection result of an image according to some embodiments of the present disclosure;

FIG. 13 is a flowchart illustrating an exemplary process for determining a target threshold according to some embodiments of the present disclosure;

FIG. 14 is a flowchart illustrating an exemplary process for spot anomaly detecting of an image according to some embodiments of the present disclosure; and

FIG. 15 is a flowchart illustrating an exemplary process for determining one or more target template images according to some embodiments of the present disclosure

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to some embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding online-to-offline service, it should also be understood that this is only one exemplary embodiment. The systems and methods of the present disclosure may be applied to any other kind of online-to-offline service. For example, the systems and methods of the present disclosure may be applied to transportation systems of different environments including land, ocean, aerospace, or the like, or a combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or a combination thereof. The transportation system may also include any transportation system for management and/or distribution, for example, a system for sending and/or receiving an express. The application of the systems and methods of the present disclosure may include a webpage, a plug-in of a browser, a client terminal, a custom system, an internal analysis system, an artificial intelligence robot, or the like, or a combination thereof.

The terms “passenger,” “requester,” “requester,” “service requester,” “service requester,” and “customer” in the present disclosure are used interchangeably to refer to an individual, an entity or a tool that may request or order a service. Also, the terms “driver,” “provider,” “service provider,” and “supplier” in the present disclosure are used interchangeably to refer to an individual, an entity or a tool that may provide a service or facilitate the providing of the service. The term “user” in the present disclosure refers to an individual, an entity or a tool that may request a service, order a service, provide a service, or facilitate the providing of the service. In the present disclosure, terms “requester” and “requester terminal” may be used interchangeably, and terms “provider” and “provider terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or a combination thereof. The service request may be accepted by any one of a passenger, a requester, a service requester, a customer, a driver, a provider, a service provider, or a supplier. The service request may be charged or free.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or a combination thereof. One or more of the above positioning technologies may be used interchangeably in the present disclosure.

The present disclosure relates to systems and methods for image quality detection. The system may obtain an image acquired by a camera. The system may determine a detection result of the image. For example, the system may determine the detection result of the image using an image quality detection model being provided by training a machine learning model using a plurality of training samples. For another example, the system may determine the detection result of the image based on a target threshold of an image quality detection model. As still another example, the system may determine the detection result of the image based on one or more target template images presenting one or more spots. In response to a determination that the detection result includes a quality anomaly of the image, the system may further generate a strategy in response to the quality anomaly. The strategy may include generating an alert for reminding related personnel associated with the camera, informing the related personnel to examine and/or repair the camera.

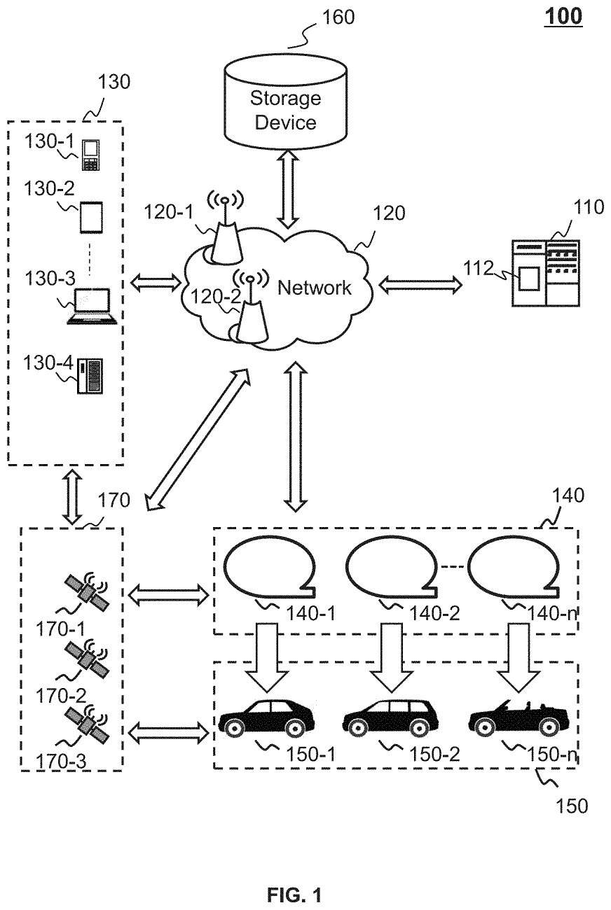

FIG. 1 is a block diagram illustrating an exemplary O2O service system 100 according to some embodiments of the present disclosure. For example, the O2O service system 100 may be an online transportation service platform for transportation services. The O2O service system 100 may include a server 110, a network 120, a requester terminal 130, a provider terminal 140, a vehicle 150, a storage device 160, and a navigation system 170. The O2O service system 100 may provide a plurality of services. Exemplary services may include a taxi-hailing service, a chauffeur service, an express car service, a carpool service, a bus service, a driver hire service, and a shuttle service. In some embodiments, the 020 service may be any online service, such as booking a meal, shopping, or the like, or any combination thereof.

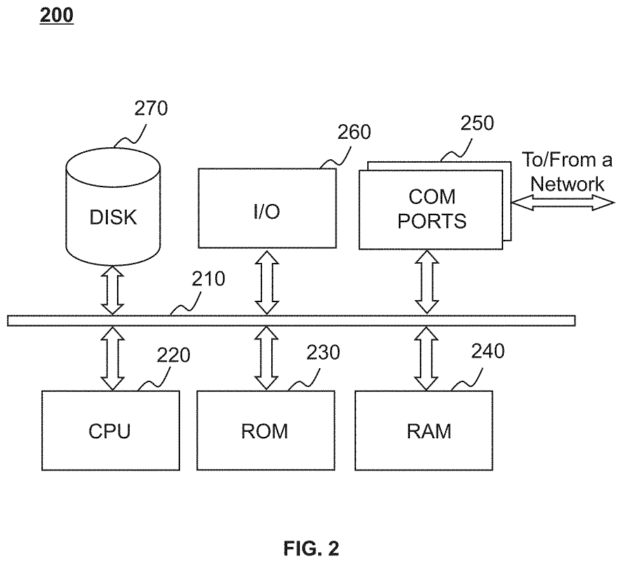

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. The processing device 112 may process information and/or data related to image anomaly detection to perform one or more functions described in the present disclosure. For example, the processing device 112 may obtain image data from a camera installed in the vehicle 150 and an image quality detection model for image anomaly detection from the storage device 160 or any other storage device. The processing device 112 may determine an image anomaly in an image using the image quality detection model. As another example, the processing device 112 may determine the image quality detection model by training a preliminary machine learning model using a plurality of samples. As a further example, the processing device 112 may determine the plurality of samples. The processing device 112 may receive the plurality of samples acquired by one or more cameras from the cameras, the requester terminal 130, the provider terminal 140, and/or the storage device 160 via the network 120. The image quality detection model may be updated from time to time, e.g., periodically or not, based on a sample set that is at least partially different from the original sample set from which the original image quality detection model is determined. For instance, the image quality detection model may be updated based on a sample set including new samples that are not in the original sample set, samples whose anomaly is assessed using the image quality detection model of a prior version, or the like, or a combination thereof. In some embodiments, the determination and/or updating of the image quality detection model may be performed on a processing device, while the application of the models may be performed on a different processing device. In some embodiments, the determination and/or updating of the image quality detection model may be performed on a processing device of a system different than the O2O service system 100 or a server different than the server 110 on which the application of the models is performed. For instance, the determination and/or updating of the image quality detection model may be performed on a first system of a vendor who provides and/or maintains such a machine learning model, and/or has access to samples used to determine and/or update the machine learning model, while image anomaly detection based on the provided machine learning model, may be performed on a second system of a client of the vendor. In some embodiments, the determination and/or updating of the image quality detection model may be performed online in response to a request for image anomaly detection. In some embodiments, the determination and/or updating of the image quality detection model may be performed offline.

In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components of the O2O service system 100 (e.g., the server 110, the requester terminal 130, the provider terminal 140, the vehicle 150, the storage device 160, and the navigation system 170) may transmit information and/or data to other component(s) of the O2O service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. In some embodiments, the provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the passenger and/or the requester terminal 130. In some embodiments, the wearable device 130-5 may include a smart bracelet, a smart footgear, smart glasses, a smart helmet, a smartwatch, smart clothing, a smart backpack, a smart accessory, or the like, or any combination thereof.

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the O2O service system 100. In some embodiments, the provider terminal 140 may be a device with positioning technology for locating the service provider, the provider terminal 140, and/or a vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the 020 service system 100.

In some embodiments, the provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., taxi-hailing service, chauffeur service, express car service, carpool service, bus service, driver hire service or shuttle service). The vehicles 150 may be installed with a camera. The camera may be configured to obtain image data via performing surveillance of an area within the camera. As used herein, a camera may refer to an apparatus for visual recording. For example, the camera may include a color camera, a digital video camera, a camera, a camcorder, a PC camera, a webcam, an infrared (IR) video camera, a low-light video camera, a thermal video camera, a CCTV camera, a pan, a tilt, a zoom (PTZ) camera, a video sensing device, or the like, or a combination thereof. The image data may include a video. The video may include a television, a movie, an image sequence, a computer-generated image sequence, or the like, or a combination thereof. The area may be reflected in the video as a scene. In some embodiments, the scene may include one or more objects of interest. The one or more objects may include a person, a vehicle, an animal, a physical subject, or the like, or a combination thereof.

The storage device 160 may store data and/or instructions. For example, the storage device 160 may store data of a plurality of travel trajectories, a plurality of orders, image data obtained by the camera in the vehicle 150, one or more machine learning models, a training set of a machine learning model, etc. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, the storage device 160 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

The navigation system 170 may determine information associated with an object, for example, one or more of the requester terminal 130, the provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a speed, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the requester terminal 130, the provider terminal 140, or the vehicle 150 via wireless connections.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to an electromagnetic signal. Similarly, a provider requester terminal 130 may receive instruction and/or a service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device 200 on which the server 110, the requester terminal 130 and/or the provider terminal 140 may be implemented according to some embodiments of the present disclosure. For example, the processing device 112 may be implemented on the computing device 200 and configured to perform functions of the processing device 112 disclosed in this disclosure.

The computing device 200 may be a special purpose computer in some embodiments. The computing device 200 may be used to implement the O2O service system 100 for the present disclosure. The computing device 200 may implement any component that performs one or more functions disclosed in the present disclosure. In FIGS. 1-2, only one such computing device is shown purely for convenience purposes. One of ordinary skill in the art would understand that the computer functions relating to the object detection as described herein may be implemented in a distributed fashion on a number of similar platforms, to distribute the processing load.

The computing device 200, may include communication ports (COM PORTS) 250 connected to and from a network (e.g., the network 120) connected thereto to facilitate data communications. The computing device 200 may also include a processor 220, in the form of one or more processors, for executing program instructions. The exemplary computer platform may include an internal communication bus 210, a program storage and a data storage of different forms, for example, a disk 270, and a read-only memory (ROM) 230, or a random access memory (RAM) 240, for various data files to be processed and/or transmitted by the computer. The exemplary computer platform may also include program instructions stored in the ROM 230, the RAM 240, and/or other types of non-transitory storage medium to be executed by the processor 220. The methods and/or processes of the present disclosure may be implemented as the program instructions. The computing device 200 also includes an I/O component 260, supporting input/output between the computing device 200 and other components. Moreover, computing device 200 may receive programs and data via the communication network.

Merely for illustration, only one processor 220 is described in the computing device 200. However, it should be noted that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both operation A and operation B, it should be understood that operation A and operation B may also be performed by two different processors jointly or separately in the computing device 200 (e.g., the first processor executes operation A and the second processor executes operation B, or the first and second processors jointly execute operations A and B).

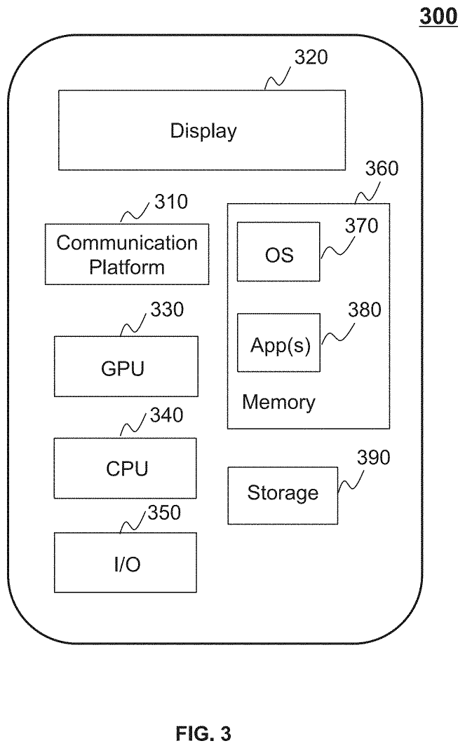

FIG. 3 is a schematic diagram illustrating exemplary hardware and/or software components of an exemplary mobile device according to some embodiments of the present disclosure. As illustrated in FIG. 3, the mobile device 300 may include a camera 305, a communication platform 310, a display 320, a graphics processing unit (GPU) 330, a central processing unit (CPU) 340, an I/O 350, a memory 360, a mobile operating system (OS) 370, application (s) 380, and a storage 390. In some embodiments, any other suitable component, including but not limited to a system bus or a controller (not shown), may also be included in the mobile device 300.

In some embodiments, the mobile operating system 370 (e.g., iOS™, Android™ Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the O2O service system 100. User interactions with the information stream may be achieved via the I/O 350 and provided to the storage device 160, the server 110 and/or other components of the O2O service system 100. In some embodiments, the mobile device 300 may be an exemplary embodiment corresponding to a terminal associated with the O2O service system 100, the requester terminal 130 and/or the provider terminal 140.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to detect an object and/or obtain samples as described herein. A computer with user interface elements may be used to implement a personal computer (PC) or other types of work station or terminal device, although a computer may also act as a server if appropriately programmed. It is believed that those skilled in the art are familiar with the structure, programming and general operation of such computer equipment and as a result, the drawings should be self-explanatory.

One of ordinary skill in the art would understand that when an element of the 020 service system 100 performs, the element may perform through electrical signals and/or electromagnetic signals. For example, when a server 110 processes a task, such as determining an image quality detection model, the server 110 may operate logic circuits in its processor to process such task. When the server 110 completes determining the image quality detection model, the processor of the server 110 may generate electrical signals encoding the image quality detection model. The processor of the server 110 may then send the electrical signals to at least one data exchange port of a target system associated with the server 110. The server 110 communicates with the target system via a wired network, the at least one data exchange port may be physically connected to a cable, which may further transmit the electrical signals to an input port (e.g., an information exchange port) of the requester terminal 130. If the server 110 communicates with the target system via a wireless network, the at least one data exchange port of the target system may be one or more antennas, which may convert the electrical signals to electromagnetic signals. Within an electronic device, such as the requester terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 160), it may send out electrical signals to a read/write device of the storage medium, which may read or write structured data in the storage medium. The structured data may be transmitted to the processor in the form of electrical signals via a bus of the electronic device. Here, an electrical signal may be one electrical signal, a series of electrical signals, and/or a plurality of discrete electrical signals.

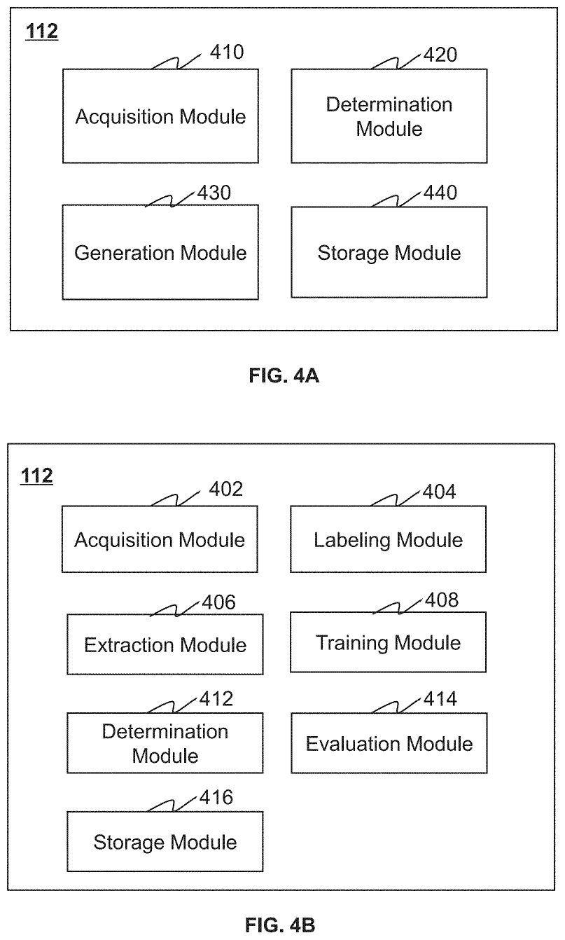

FIG. 4A is a block diagram illustrating an exemplary processing device 112 according to some embodiments of the present disclosure. The processing device 112 may include an acquisition module 410, a determination module 420, a generation module 430, and a storage module 440.

The acquisition module 410 may obtain data related to image quality detection application. In some embodiments, the acquisition module 410 may obtain an image acquired by a camera. The camera may be configured to perform surveillance of an area of interest (AOI) or an object of interest within a scope of the camera as described elsewhere in the present disclosure (e.g., FIG. 1 and the description thereof).

In some embodiments, the processing device 112 may receive a request for image quality detection. In response to the request for image quality detection, the acquisition module 410 may obtain the image captured by the camera. In some embodiments, the processing device 112 may receive a request for examining the operation state of a camera. In response to the request for examining the operation state of a camera, the acquisition module 410 may obtain the image captured by the camera. In some embodiments, the processing device 112 may receive a request for safety surveillance of the environment inside the vehicle. In response to the request for safety surveillance, the acquisition module 410 may receive the image in real time, wherein the image is captured by a camera installed in a vehicle providing the online to offline service (e.g., a transport service).

In some embodiments, the acquisition module 410 may obtain the image from one or more components of the O2O service system 100, such as a storage device (e.g., the storage device 160, the storage of the computing device 200, the storage 390), the requester terminal 130, the provider terminal 140, the camera installed with the vehicles 150, or the like, or any combination thereof. In some embodiments, the acquisition module 410 may obtain the image from time to time, e.g., periodically.

In some embodiments, the acquisition module 410 may obtain an image quality detection model. The image quality detection model may be configured to evaluate the quality of the image. For example, the image quality detection model may be configured to determine whether an image is anomalous. A detection result of the image produced by the image quality detection model may include that the image is anomalous or normal. In some embodiments, the image quality detection model may be configured to determine one or more quality anomalies that the image includes in response to a determination that the image is anomalous. A detection result of the image produced by the image quality detection model may include the one or more quality anomalies.

In some embodiments, the image quality detection model may be provided by training a machine learning model using a plurality of training samples. For example, the image quality detection model may be constructed based on a neural network model, a regression model, a support vector machine (SVM) model, or the like, or a combination thereof. In some embodiments, the image quality detection model may be implemented on a computing device (e.g., the processing device 112, the computing device 200, the mobile device 300, etc.) as an application.

In some embodiments, the acquisition module 410 may obtain one or more target template images each of which may present one or more spots. The one or more target template images may be configured to detect a spot anomaly in the image. As used herein, a spot presented in a target template image may be referred to as a region including one or more specific characteristics, such as a shape, a size, an arrangement shape, an orientation, etc.

In some embodiments, the acquisition module 410 may obtain the one or more target template images from one or more components of the O2O service system 100, such as a storage device (e.g., the storage device 160, the storage of the computing device 200, the storage 390), the requester terminal 130, the provider terminal 140, the camera installed with the vehicles 150, or the like, or any combination thereof.

The determination module 420 may determine a detection result of the image using the image quality detection model. For example, the determination module 420 may determine whether a specific image includes a quality anomaly using the image quality detection model. Exemplary quality anomalies of an image may include a blocking anomaly, a blur anomaly, an angle anomaly, a color cast anomaly, a fill light anomaly, etc. As used herein, the blocking anomaly of an image may refer to that at least a portion of the image cannot present a scene in the field view of a camera. The blocking anomaly may include a partially blocking and an entirely blocking. The partially blocking may refer to that a portion of the image does not present a scene in the field view of a camera. The entirely blocking may refer to that the entire image does not present a scene in the field view of a camera. The angle anomaly of the image may refer to that at least a portion of a scene recorded by the image is not within in a preset field view of a camera caused by the abnormal orientation or offset of the lens (i.e., the shooting angle of the camera) of the camera, for example, shifting upward, shifting downward, shifting to the left, shifting to the right, etc. The blur anomaly of the image may refer to that an ambiguity of the image exceeds a first threshold or a definition of the image is less than a second threshold. The color cast anomaly may refer to that a difference between the color of the image and the actual color of subjects the image recording exceeds a threshold. The fill light anomaly of an image may refer to that the brightness of the image is less than a threshold.

The generation module 430 may, in response to a determination that the detection result includes a quality anomaly of the image, generate a strategy in response to the quality anomaly. The strategy may include generating an alert for reminding a related personnel (e.g., a driver, a passenger, an engineer, a repair personnel, etc.) associated with the camera that the image is anomalous, informing a related personnel (e.g., a driver, a passenger, an engineer, a repair personnel, etc.) associated with the camera to examine and/or repair the camera, generating a suggestion for removing the quality anomaly in the image, etc.

The storage module 440 may be configured to store intermediate results produced during data processing. The intermediate results may include the image, the strategy, the detection result, or the like, or any combination thereof. In some embodiments, the storage module 440 may store one or more programs and/or instructions that may be executed by the processor(s) of the processing engine 112 to perform exemplary methods described in this disclosure. For example, the storage module 440 may store program(s) and/or instruction(s) that can be executed by the processor(s) of the processing engine 112 to acquire the image, and/or store a detection result.

The modules in the processing device 112 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. Two or more of the modules may be combined into a single module, and any one of the modules may be divided into two or more units.

FIG. 4B is a block diagram illustrating an exemplary processing device 112 according to some embodiments of the present disclosure. The processing device 112 may include an acquisition module 402, a labeling module 404, an extraction module 430, a training module 408, a determination module 412, an evaluation module 414, and a storage module 416.

The acquisition module 402 may obtain data related to image quality detection. In some embodiments, the acquisition module 402 may obtain a plurality of training samples. The plurality of training samples may be configured to train a machine learning model to obtain an image quality detection model as described in FIG. 4A. In some embodiments, each of the plurality of training samples may include an image capturing a specific scene in the space surrounding and outside of a vehicle. In some embodiments, each of the plurality of training samples may include an image capturing a specific scene in the space inside a vehicle.

The acquisition module 402 may obtain the plurality of training samples from a storage device (e.g., the storage device 160, the ROM 230, the RAM 240, the storage 390) as described elsewhere in the present disclosure. The plurality of training samples may include normal images and abnormal images. The abnormal images may include at least one of a blur anomaly, a blocking anomaly, a cast color anomaly, an angle anomaly, a spot anomaly, a fill light anomaly, etc. In some embodiments, at least a portion of the plurality of training samples may include at least two anomalies of the blur anomaly, the blocking anomaly, the cast color anomaly, the angle anomaly, the spot anomaly, the fill light anomaly, etc.

The labeling module 404 may label each of the plurality of training samples with a label. A label of a training sample may indicate whether the training sample includes a specific image anomaly. For example, a label of a training sample may include a positive sample indicating that the sample is normal. A label of a training sample may include a negative sample indicating that the training sample is anomalous or includes a specific image anomaly (e.g., the blur anomaly, the blocking anomaly, the cast color anomaly, the angle anomaly, the fill light anomaly, etc.).

The extraction module 406 may extract one or more features associated with pixels in the each of the labeled training samples. Exemplary features associated with pixels in the each of the labeled training samples may include a color feature, a texture feature, a shape feature, a spatial relationship feature, etc. As used herein, the one or more features associated with the pixels (e.g., the color feature) in the image may be also referred to as image features. In some embodiments, the image features may be described using a gradient feature, a histogram feature, etc. in the gray mode, or in the HSV mode, or any other mode. In some embodiments, the image features associated with the pixels (e.g., the color feature) may be described using a hue, a saturation, a value, etc., in the HSV mode.

The training module 408 may train a machine learning model based on the each of the plurality of training samples and corresponding label to obtain a trained machine learning model. In some embodiments, the training module 408 may input the each of the plurality of training samples and the corresponding label into the machine learning model to train the machine learning model using a model training algorithm. Exemplary model training algorithms may include a gradient descent algorithm, Newton's algorithm & Quasi-Newton algorithms, a conjugate gradient algorithm, a back propagation (BP) algorithm, etc. In some embodiments, the image features of each of the plurality of training sample may be as an input of the machine learning model during the training process of the machine learning model.

The determination module 412 may determine data related to the training and/or construction of the image quality detection model. In some embodiments, the determination module 412 may determine one or more specific cameras whose lamps are in breakdown based on the plurality of candidate images. At least a portion of the plurality of training samples may be obtained from the one or more specific cameras. In some embodiments, the determination module 412 may determine a target threshold of the image quality detection model. For example, the determination module 412 may determine the target threshold based on a plurality of samples, each of at least a portion of the plurality of samples having a reference label indicating that each of the at least a portion of the plurality of samples having a color cast anomaly. In some embodiments, the determination module 412 may determine one or more target template images. The one or more target template images may present the one or more spots with different characteristics in different target template images. As used herein, different characteristics (e.g., size, shape, etc.) of two spots in two different target template images may refer to that a similarity degree between the characteristics of the two spots is less than a similarity threshold (e.g., 0.9, 0.8, etc.).

The evaluation module 414 may evaluate data related to the image quality detection model. In some embodiments, the evaluation module 414 may evaluate the image quality detection model with respect to each of the plurality of candidate thresholds according to one or more evaluation indexes. Exemplary evaluation indexes of the image quality detection model may include a precision rate, a recall rate, an accuracy rate, an error rate, a sensitive, a sensitive, a receiver operating characteristic (ROC), an area under ROC curve (AUC), a Gini coefficient, or the like, or any combination thereof. In some embodiments, the evaluation module 414 may evaluate one or more candidate template images according to an evaluation index. The one or more candidate template images may be images presenting one or more spots.

The storage module 416 may be configured to store intermediate results produced during data processing. The intermediate results may include the plurality of samples, the one or more target template images, the one or more evaluation indexes, the one or more candidate template images, the image features, the labels, or the like, or any combination thereof. In some embodiments, the storage module 416 may store one or more programs and/or instructions that may be executed by the processor(s) of the processing engine 112 to perform exemplary methods described in this disclosure. For example, the storage module 416 may store program(s) and/or instruction(s) that can be executed by the processor(s) of the processing engine 112 to evaluate the one or more candidate template images, and/or store the one or more target template images.

The modules in the processing device 112 may be connected to or communicate with each other via a wired connection or a wireless connection. The wired connection may include a metal cable, an optical cable, a hybrid cable, or the like, or a combination thereof. The wireless connection may include a Local Area Network (LAN), a Wide Area Network (WAN), a Bluetooth, a ZigBee, a Near Field Communication (NFC), or the like, or a combination thereof. Two or more of the modules may be combined into a single module, and any one of the modules may be divided into two or more units.

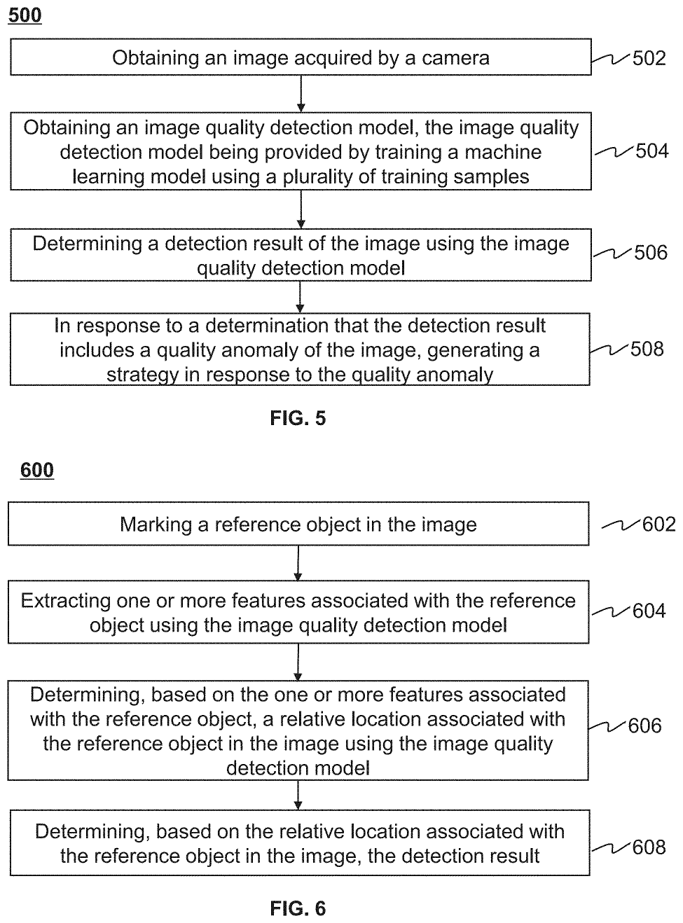

FIG. 5 is a flowchart illustrating an exemplary process for detecting an image quality according to some embodiments of the present disclosure. Process 500 may be executed by the O2O service system 100. For example, the process 500 may be implemented as a set of instructions (e.g., an application) stored in the storage device 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5 and described below is not intended to be limiting.

In 502, the processing device 112 (e.g., the acquisition module 410) may obtain an image acquired by a camera. The camera may be configured to perform surveillance of an area of interest (AOI) or an object of interest within a scope of the camera as described elsewhere in the present disclosure (e.g., FIG. 1 and the description thereof). In some embodiments, the camera may be mounted on a vehicle (e.g., the vehicle 150), for example, inside and/or outside of the vehicle and configured to monitor an environment associated with the vehicle. For example, the camera may be configured to monitor the space surrounding and outside of the vehicle. The camera may be installed inside and/or outside of the vehicle. If the camera is installed inside of the vehicle, the camera may capture the scene outside the vehicle through a windshield of the vehicle (e.g., the front windshield of the vehicle). As another example, the camera may be configured to monitor the environment inside a vehicle. In some embodiments, the camera may be working in an abnormal state when the camera captures the image. For example, the abnormal state may include that the lens of the camera is blocked, the orientation of the lens is not right, the lens of the camera is blurred, the fill light of the camera is not working properly, etc.

The image may be a two-dimensional (2D) image, a three-dimensional (3D) image, a four-dimensional (4D), or any other type of image. The image may be stored in any image format, such as a RAW format (e.g., unprocessed processed image data), a tagged input file format (TIFF), a joint photographic experts group format (JPEG), a graphics interchange format (GIF), a bitmap format (BMP), or the like, or the combination thereof. In some embodiments, the image may be obtained from one or more components of the O2O service system 100, such as a storage device (e.g., the storage device 160, the storage of the computing device 200, the storage 390), the requester terminal 130, the provider terminal 140, the camera installed with the vehicles 150, or the like, or any combination thereof. In some embodiments, the processing device 112 may obtain the image from time to time, e.g., periodically. For example, the processing device 112 may obtain the image from the camera installed on the vehicles 150 per week, or per month, or per quarter, etc. As another example, the processing device 112 may obtain the image from the camera installed on the vehicles 150 in real time. In some embodiments, the processing device 112 may receive a request for image quality detection. In response to the request for image quality detection, the processing device 112 may obtain an image captured by the camera. In some embodiments, the processing device 112 may receive a request for examining the operation state of a camera. In response to the request for examining the operation state of a camera, the processing device 112 may obtain the image captured by the camera. In some embodiments, the processing device 112 may receive a request for safety surveillance of the environment inside the vehicle. For example, a request for safety surveillance may be initiated when an online to offline service is initiated. In response to the request for safety surveillance, the processing device 112 may receive the image in real time, wherein the image is captured by a camera installed in a vehicle providing the online to offline service (e.g., a transport service).

In 504, the processing device 112 (e.g., the acquisition module 410) may obtain an image quality detection model. The image quality detection model may be provided by training a machine learning model using a plurality of training samples. The image quality detection model may be configured to evaluate the quality of a specific image captured by a camera. For example, the processing device 112 may determine whether the specific image includes a quality anomaly using the image quality detection model. Exemplary quality anomalies of an image may include a blocking anomaly, a blur anomaly, an angle anomaly, a color cast anomaly, a fill light anomaly, etc. As used herein, the blocking anomaly of an image may refer to that at least a portion of the image cannot present a scene in the field view of a camera. The blocking anomaly may include a partially blocking and an entirely blocking. The partially blocking may refer to that a portion of the image does not present a scene in the field view of a camera. The entirely blocking may refer to that the entire image does not t present a scene in the field view of a camera. For example, the blocking anomaly of an image may happen when the lens of the camera is blocked by, for example, a shading board installed inside a vehicle, a chewing gum, the body of a driver, spots on the lens or the windshield in front of the lens, or any other physical subject. The angle anomaly of the image may refer to that at least a portion of a scene recorded by the image is not within in a preset field view of a camera caused by the abnormal orientation or offset of the lens (i.e., the shooting angle of the camera) of the camera, for example, shifting upward, shifting downward, shifting to the left, shifting to the right, etc. The blur anomaly of the image may refer to that an ambiguity of the image exceeds a first threshold or a definition of the image is less than a second threshold. The blur anomaly of the image may be caused by a protective film on the lens, a windshield in the front of the lens, stains on the lens, etc. The color cast anomaly may refer to that a difference between the color of the image and the actual color of subjects the image recording exceeds a threshold. The color cast anomaly may happen when the lens of the camera is damaged, when the lens of the camera is covered by a colored membrane or a filter, etc. The fill light anomaly of an image may refer to that the brightness of the image is less than a threshold. The fill light anomaly may be caused by a failure of the supplementary lamp of the camera.

In some embodiments, the image quality detection model may be configured to determine whether an image is anomalous. A detection result of the image produced by the image quality detection model may include that the image is anomalous or normal. In some embodiments, the image quality detection model may be configured to determine one or more quality anomalies that the image includes in response to a determination that the image is anomalous. A detection result of the image produced by the image quality detection model may include the one or more quality anomalies. For example, the image quality detection model may be configured to detect the blocking anomaly and/or the angle anomaly. A detection result of the image produced by the image quality detection model may include a blocking anomaly and/or the angle anomaly, or a normal result. More descriptions of the image quality detection model configured to detect the blocking anomaly and/or the angle anomaly may be found elsewhere in the present disclosure (e.g., FIG. 6 and the descriptions thereof). As another example, the image quality detection model may be configured to detect the blur anomaly and/or the fill light anomaly based on one or more features associated with pixels in the image. A detection result of the image produced by the image quality detection model may include the blur anomaly and/or the fill light anomaly, or a normal result. More descriptions of the image quality detection model configured to detect the blur anomaly and/or the fill light anomaly may be found elsewhere in the present disclosure (e.g., FIG. 8 and the descriptions thereof). As still another example, the image quality detection model may be configured to detect at least one of the blocking anomaly, a blur anomaly, an angle anomaly, a color cast anomaly, a fill light anomaly, etc. A detection result of the image produced by the image quality detection model may include at least one of the blocking anomaly, a blur anomaly, an angle anomaly, a color cast anomaly, a fill light anomaly, etc., or a normal result. In some embodiments, the image quality detection model may be configured to determine a score indicating a probability that the image includes each of the at least one of the one or more quality anomalies. A detection result of the image produced by the image quality detection model may include a score corresponding to each of the at least one of the one or more quality anomalies.

The image quality detection model may be constructed based on a neural network model, a regression model, a support vector machine (SVM) model, or the like, or a combination thereof. Exemplary neural network models may include a convolutional machine learning model (CNN), a fully convolutional neural network (FCN) model, a generative adversarial network (GAN), a back propagation (BP) machine learning model, a radial basis function (RBF) machine learning model, a deep belief nets (DBN) machine learning model, an Elman machine learning model, or the like, or a combination thereof. Exemplary regression models may include a linear regression model, a logistic regression model, a polynomial regression model, a stepwise regression model, a ridge regression model, a lasso regression model, an ElasticNet regression model, or the like, or a combination thereof. In some embodiments, the image quality detection model may be constructed based on one single machine learning model. The one single machine learning model may be configured to detect at least one of the blocking anomaly, the blur anomaly, the angle anomaly, the color cast anomaly, the fill light anomaly included in an inputted image, etc. For example, the single machine learning model may be configured to detect one of the blocking anomaly, the blur anomaly, the color cast anomaly, and the fill light anomaly included in an inputted image capturing a scene inside the vehicle. As another example, the single machine learning model may be configured to detect the angle anomaly, the blocking anomaly, and the blur anomaly included in an inputted image capturing a scene outside the vehicle. As still another example, the single machine learning model may be configured to detect at least two of the blocking anomaly, the blur anomaly, the angle anomaly, the color cast anomaly, and the fill light anomaly simultaneously.

In some embodiments, the image quality detection model may be constructed based on a plurality of sub-models. Each of at least a portion of the plurality of sub-models may be configured to detect one of the blocking anomaly, the blur anomaly, the angle anomaly, the color cast anomaly, and the fill light anomaly. The plurality of sub-models may be constructed based on the same or different models. For example, a first sub-model configured to detect the blocking anomaly may be constructed based on a neural network model. A second sub-model configured to detect the angle anomaly may be constructed based on a neural network model and/or a regression model. A third sub-model configured to detect the blur anomaly may be constructed based on an SVM model. In some embodiments, at least a portion of the plurality of sub-models (e.g., the first sub-model and the second sub-model) may be independent of each other. The training of the first sub-model and the second sub-model may be independent. In some embodiments, at least a portion of the plurality of sub-models (e.g., the first sub-model and the third sub-model) may be connected with each other via, for example, a node, a layer, etc. At least a portion of the plurality of sub-models (e.g., the first sub-model and the third sub-model) may be trained as a whole to determine the image quality detection model.

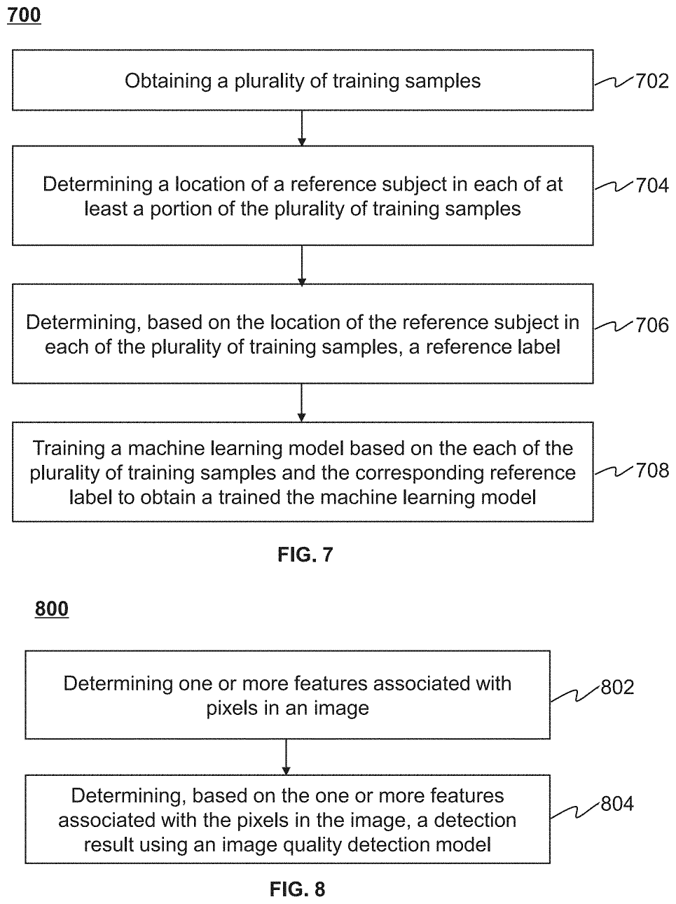

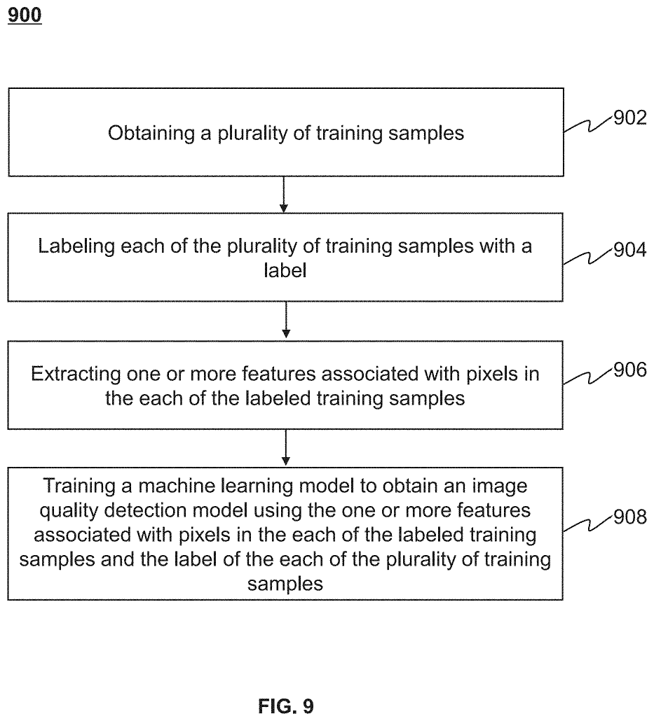

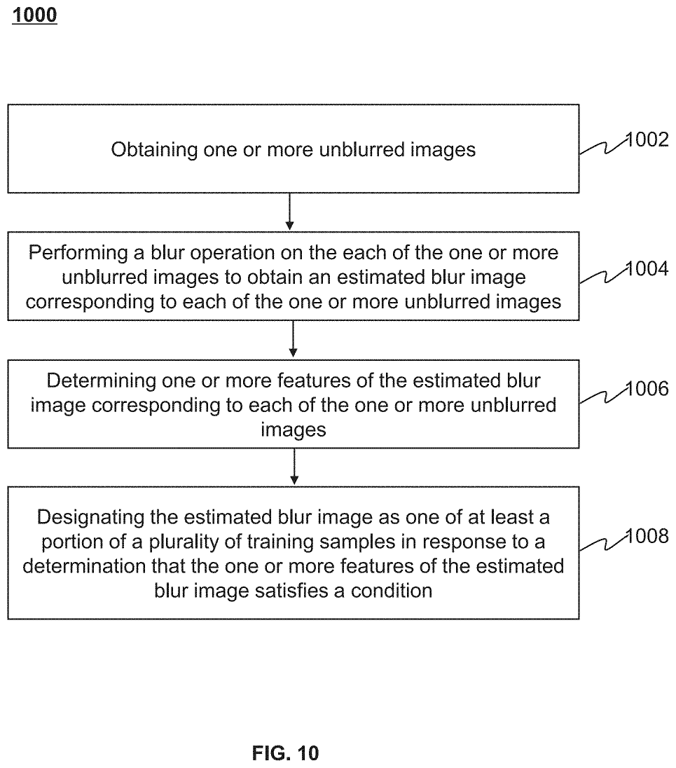

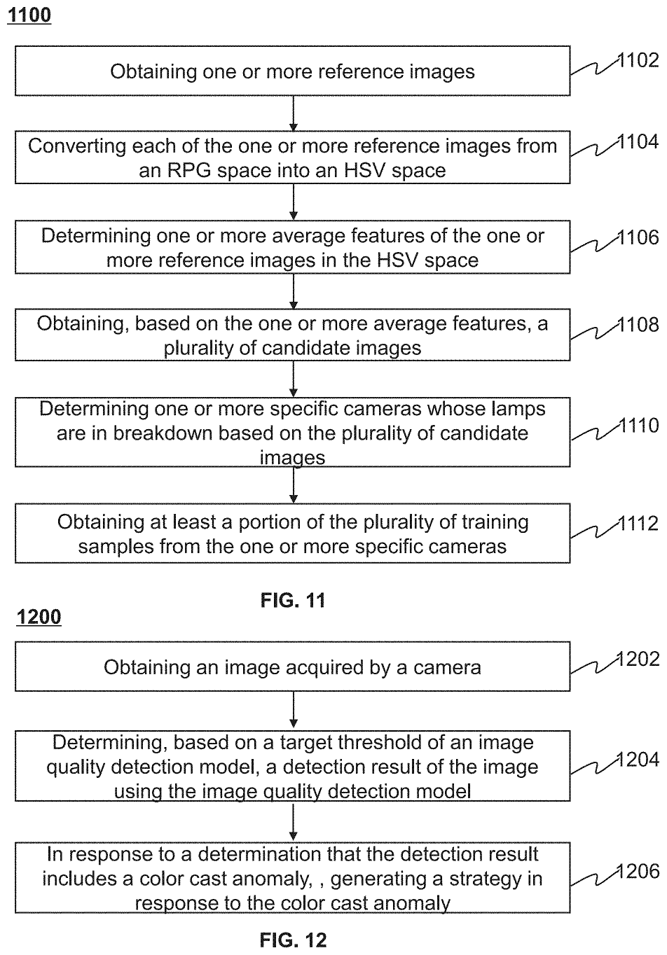

The image quality detection model may be obtained from the storage device 160, or any other storage device. For example, a processor may generate the image quality detection model by training a machine learning model based on the plurality of training samples using a model training algorithm and store the trained machine learning model in the storage device 160. Exemplary model training algorithms may include a gradient descent algorithm, Newton's algorithm, a Quasi-Newton algorithm, a Levenberg-Marquardt algorithm, a conjugate gradient algorithm, or the like, or a combination thereof. More descriptions of the training of the machine learning model may be found elsewhere in the present disclosure (e.g., FIGS. 7, 9 and the descriptions thereof). The plurality of training samples may include normal images and abnormal images. As used herein, a normal image may refer to an image with none of the image anomalies as described in operation 504. A normal image may also be referred to as a positive sample. An abnormal image may refer to an image with at least one of the image anomalies as described in operation 504. An abnormal image may also be referred to as a negative sample. For example, the plurality of training samples for training the image quality detection model that is configured to detect blur anomaly may include blurred images and clear images. In some embodiments, the plurality of training samples may be divided into different groups. Each group of training samples may include a plurality of images. At least a portion of the plurality images may include a specific quality anomaly (e.g., a blur anomaly). Images in different groups may include different quality anomalies. For example, samples in a first group may include a blur anomaly, and samples in a second group may include a blocking anomaly. Each of the samples in the first group may be labeled with a label indicating that the sample includes the blur anomaly. Each of the samples in the second group may be labeled with a label indicating that the sample includes the blocking anomaly. More descriptions for the plurality of training samples may be found elsewhere in the present disclosure (e.g., FIGS. 10 and 11 and the descriptions thereof).

In 506, the processing device 112 (e.g., the determination module 420) may determine a detection result of the image using the image quality detection model.

In some embodiments, the processing device 112 may input the image obtained in 502 to the image quality detection model. The detection result may be generated by the image quality detection model based on the inputted image obtained in 502. In some embodiments, the detection result may indicate whether the image is qualified or anomalous. In some embodiments, the detection result may include a specific quality anomaly, for example, one of the blocking anomaly, the blur anomaly, the angle anomaly, the color cast anomaly, the fill light anomaly, etc., in response to a determination that the image is anomalous. In some embodiments, the processing device 112 may determine a coincidence level corresponding to each of one or more quality anomalies. The coincidence level may indicate a probability that the corresponding quality anomaly is detected in the image. The processing device 112 may determine the detection result based on the coincidence level corresponding to each of one or more quality anomalies. For example, the processing device 112 may determine that the image is anomalous or includes a quality anomaly (e.g., one of the blocking anomaly, the blur anomaly, the angle anomaly, the color cast anomaly, the fill light anomaly, etc.,) in response to a determination that the coincidence level corresponding to quality anomaly (e.g., one of the blocking anomaly, the blur anomaly, the angle anomaly, the color cast anomaly, the fill light anomaly, etc.,) is less than a coincidence level threshold. As another example, the coincidence level with a value of “1” may indicate that the corresponding quality anomaly is detected in the inputted image, and the coincidence level with a value of “0” may indicate that the corresponding image anomaly is not detected in the inputted image. In some embodiments, the detection result may be a vector outputted by the image quality detection model. Each element of the vector may include a coincidence level corresponding to a specific image anomaly. For example, an element corresponding to the blur anomaly may be “1”, and an element corresponding to the blocking anomaly may be “0”, which indicate that the image includes the blur anomaly.

In some embodiments, the processing device 112 may determine the detection result based on one or more features associated with the image using the image quality detection model. The one or more features associated with the image may include one or more features associated with a reference object (e.g., a location of the reference object in the image) and/or one or more features associated with pixels (e.g., pixel values, a gradient feature, a histogram feature, etc.) in the image. The feature associated with pixels (e.g., pixel values, a gradient feature, a histogram feature, etc.) in the image may be also referred to as an image feature. For example, the processing device 112 may extract the features associated with the image and input the extracted features into the image quality detection model. More descriptions regarding the one or more features of the image may be found elsewhere in the disclosure. See, e.g., FIGS. 6, 8 and the descriptions thereof.

In 508, in response to a determination that the detection result includes a quality anomaly of the image, the processing device 112 (e.g., the generation module 430) may generate a strategy in response to the quality anomaly.

The strategy may include generating an alert for reminding a related personnel (e.g., a driver, a passenger, an engineer, a repair personnel, etc.) associated with the camera that the image is anomalous, informing a related personnel (e.g., a driver, a passenger, an engineer, a repair personnel, etc.) associated with the camera to examine and/or repair the camera, generating a suggestion for removing the quality anomaly in the image, etc. In some embodiments, the processing device 112 may generate a signal including the strategy and detection result and transmit the signal to a terminal (e.g., a mobile terminal) associated with the related personnel. The signal may be also configured to direct the terminal to display the strategy and/or the detection result to the related personnel. The processing device 112 may determine the strategy based on the quality anomaly. For example, in response to a determination that the detection result includes an angle anomaly in the image collected by the camera, the processing device 112 may generate the strategy including a suggestion for removing the angle anomaly, which caused the quality anomaly of the image. Further, if the processing device 112 determines that the detection result includes the angle anomaly caused by the shooting angle of the camera installed inside a vehicle, the processing device 112 may suggest the driver or other related personnel to adjust the orientation of the lens of the camera. If the processing device 112 determines that the detection result includes the blur anomaly in the image collected by a camera installed inside a vehicle, the processing device 112 may suggest the driver or other related personnel to clean the lens of the camera and/or the windshield of the vehicle, or check whether the protective film of the lens of the camera has been removed. If the processing device 112 determines that the detection result includes the blur anomaly in the image collected by a camera installed inside a vehicle, the processing device 112 may suggest the driver or other related personnel to check whether the lens of the camera is covered by a filter film. If the detection result includes a fill light anomaly, the processing device 112 may suggest a maintenance personnel and/or a transportation department to schedule maintenance for the camera.

In some embodiments, during an on-demand service, in response to a determination that a blocking anomaly, a color cast, or a blur anomaly is detected, the processing device 112 may transmit an alert signal to a third party requesting the third party to intervene. For example, when it is determined that the lens of the camera is blocked intentionally, the processing device 112 may determine that the on-demand service is potentially dangerous, and may transmit an alert signal to the driver, the passenger and/or a transportation department. The driver may be asked to adjust the camera to a normal working state. The passenger may be informed to be on the alert, or remind the driver to adjust the camera to a normal working state. The transportation department may take actions like dispatching a policeman to check the vehicle on-site or block the road that the vehicle will pass through.

In some embodiments, the processing device 112 may determine the strategy based on the quality anomaly and an application scenario of the camera. The application scenario may be an installation scenario, a malfunction scenario, etc. The installation scenario may be associated with an installation of the camera in the vehicle. The malfunction scenario may be associated with the working state of the camera during an on-demand service provided by the vehicle. In some embodiments, during installation, in response to a determination that a blocking anomaly, a color cast, or a blur anomaly is detected, the processing device 112 may transmit a signal to a third party requesting the third party to intervene. For example, when it is determined that the lens of the camera is blurred, the processing device 112 may transmit an overhauling signal to a maintenance personnel and/or a transportation department to clean the lens of the camera.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 500. The processing device 112 may store the image, the strategy, the detection result in any storage device (e.g., the storage device 160) disclosed elsewhere in the present disclosure.

FIG. 6 is a flowchart illustrating an exemplary process for determining a detection result of an image according to some embodiments of the present disclosure. The process 600 may be executed by the O2O service system 100. For example, the process 600 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process as illustrated in FIG. 6 and described below is not intended to be limiting. In some embodiments, one or more operations of the process 600 may be performed to achieve at least part of operation 506 as described in connection with FIG. 5.

In 602, the processing device 112 (e.g., the determination module 420) may mark a reference object in an image. The image may be obtained as described in connection with operation 502 as described in FIG. 5. In some embodiments, the image may be collected by a camera installed inside a vehicle. The reference object may be a component or a part of the vehicle (e.g., A-pillar, B-pillar, C-pillar, a neck pillow of a seat, etc.), the skyline, etc. In some embodiments, the processing device 112 may determine the reference object based on the field view of the camera. For example, if the field view of the camera includes an area outside of the camera, the processing device 112 may determine the skyline as the reference object. As used herein, the skyline presented in an image may refer to a boundary segmenting the sky and non-sky regions in the image. The skyline may be presented in the image as a line with clear edge features. As another example, if the field view of the camera includes an area inside of the camera, the processing device 112 may determine at least one component or a part of a vehicle as the reference object. The component of the vehicle may include A-pillar, B-pillar, C-pillar, a neck pillow, etc.

In some embodiments, the processing device 112 may determine and/or identify the reference object from the image and/or locate the identified reference object. For example, the processing device 112 may use a bounding box (e.g., a rectangle box) to locate the identified reference object in the image. In some embodiments, the processing device 112 may determine a region including the reference object. The processing device 112 may enclose the region including the reference object using the bounding box. For example, the processing device 112 may mark the skyline in the image by determining a skyline region based on the bonnet of the vehicle in the image. The upper edge of the skyline region may be the skyline, and the bottom edge of the skyline region is the bonnet of the vehicle. The processing device 112 may use a bounding box to cover the skyline region.

In some embodiments, the processing device 112 may determine and/or identify the reference object from the image using an image segmentation algorithm. Exemplary image segmentation algorithms may include a threshold-based segmentation algorithm, an edge-based segmentation algorithm, a region-based segmentation algorithm, a depth information-based algorithm, a prior information-based algorithm, or the like, or any combination thereof. In some embodiments, the processing device 112 may determine and/or identify the reference object using an object detection algorithm. Using the object detection algorithm, the reference object may be recognized from the image and the position of the reference object may be determined in the image. Exemplary object detection algorithms may include applying a region-based convolutional network (R-CNN), a spatial pyramid pooling network (SPP-Net), a fast region-based convolutional network (Fast R-CNN), a faster region-based convolutional network (Faster R-CNN), etc. In some embodiments, the reference object from the image may be identified and/or determined by an operator manually.

In 604, the processing device 112 (e.g., the determination module 420) may extract one or more features associated with the reference object using an image quality detection model. The image quality detection model may be obtained as described in connection with operation 504 illustrated in FIG. 5. For example, the image quality detection model may be used to perform a blocking anomaly detection and/or angle anomaly detection. As another example, the image quality detection model may be constructed based on a CNN sub-model and/or a regression sub-model. The CNN sub-model may be configured to extract the one or more features associated with the reference object. The regression sub-model may be configured to determine whether the image includes a blocking anomaly and/or an angle anomaly. As still another example, the image quality detection model may be constructed based on a CNN model configured to extract the one or more features associated with the reference object and determine a probability that the image includes a blocking anomaly and/or an angle anomaly. In some embodiments, the one or more features associated with the reference object may be measurable properties or characteristics of the reference object. Exemplary features associated with the reference object may include a low-level feature, a high-level feature (e.g., a semantic feature), a complicated feature (e.g., a deep hierarchical feature that is determined by the image quality detection model), or the like, or any combination thereof. Exemplary low-level features may include a color-based feature (e.g., an RGB feature, a greyscale feature, etc.), a texture-based feature (e.g., a Local Binary Pattern (LBP) feature, etc.), a normalization-based feature (e.g., an illumination normalized feature, a color normalized feature, etc.), a gradient-based feature (e.g., a histogram of oriented gradients (HOG) feature, a gradient location and orientation histogram (GLOH) feature, etc.), or the like, or any combination thereof. In some embodiments, a high-level feature may be determined by analyzing the low-level feature image quality detection model. A complicated feature may be determined by analyzing the high-level features using image quality detection model.

In 606, the processing device 112 (e.g., the determination module 420) may determine, based on the one or more features associated with the reference object, a relative location associated with the reference object in the image using the image quality detection model. In some embodiments, the relative location associated with the reference object (e.g., the skyline) in the image may be defined by a center location of the region including the reference object in the image. For example, the relative location associated with the reference object may be denoted by a longitudinal coordinate of the center location of the region in an image coordinate system. In some embodiments, the center location of the image may be defined by a center location of the region including the reference object in the image with respect to the center of the image. For example, if the reference object includes the skyline, the region including the skyline may be marked by a rectangle box. The rectangle box may include the skyline, two edges of the image, and the head top of the headstock as four sides. The center location of the region may be a location of a center point of the rectangle box. The location of the center point of the rectangle box may be used to denote the relative location of the skyline in the image.

In some embodiments, the processing device 112 may determine the relative location associated with the reference object (e.g., the skyline) in the image using the image quality detection model (e.g., the regression sub-model). For example, the processing device 112 may input the features of the reference object into the image quality detection model. The image quality detection model may determine the relative location of the reference object based on the features of the reference object.

In 608, the processing device 112 (e.g., the determination module 420) may determine, based on the relative location associated with the reference object in the image, a detection result. In some embodiments, the detection result may include that the image is normal or anomalous. In some embodiments, the detection result may include that the image includes one of an angle anomaly, a blocking anomaly, and a normal state.

In some embodiments, the relative location of the reference object may denote a probability that the image includes the angle anomaly. The greater the relative location is, the smaller that the probability that the image includes the angel anomaly. In some embodiments, the processing device 112 may determine the detection result based on a comparison between the relative location associated with the reference object and a reference threshold. For example, the relative location may be a constant between 0 to 1. The processing device 112 may determine that the image includes the angle anomaly in response to a determination that the relative location is less than a threshold (e.g., 0.8, 0.7, etc.) or in a range (e.g., 0.3-0.5, 0-0.5, etc.). In some embodiments, the processing device 112 may determine the detection result based on a comparison between the relative location associated with the reference object and a reference location. The reference location of the reference object may be the location of the reference object in a normal image or a center location of the image. In some embodiments, the processing device 112 may compare the relative location and the reference location of the reference object by determining a distance between the relative location of the reference object and the reference location of the reference object. If the processing device 112 determines the distance between the relative location of the reference object and the reference location of the reference object exceeds a threshold, the processing device 112 may determine that the image includes the angle anomaly.

For a camera installed inside a vehicle configured to perform surveillance of an area in front of the vehicle. The processing device 112 may determine the skyline as the reference object. The processing device 112 may determine the center of the image as the reference location. The processing device 112 may determine the detection result by comparing the relative location of the skyline and the central location of the image using the image quality detection model. For example, the processing device 112 may determine a score indicating a difference between longitudinal coordinates of the relative location and the central location of the image in the image coordinate system. If the score indicating the difference between longitudinal coordinates of the relative location and the reference location exceeds a threshold, the processing device 112 may determine that the image includes the angle anomaly. The processing device 112 may also determine the camera shifting upward or downward based on the longitudinal coordinates of the relative location and the central location. For example, if the image coordinate system includes an origin with the center point of the image, the processing device 112 may determine the camera shifting upward in response to determine that the longitudinal coordinate of the relative location is less than the center location. The threshold may be default settings of the O2O service system 100 or may be adjustable under different situations. For example, the threshold may be 0.8, or 0.3, or 0.5. The processing device 112 may determine whether the value of the relative location of the skyline is outside the normal threshold range. In response to a determination that the value of the relative location of the skyline is outside the normal threshold range, the processing device 112 may determine that the angle anomaly is detected in the image.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 600. In the storing operation, the processing device 112 may store security score, the historical data, the transportation service information in any storage device (e.g., the storage device 160) disclosed elsewhere in the present disclosure. In some embodiments, operation 602 may be omitted. The processing device 112 may identify the reference object from the image based on the one or more features of the reference object using the image quality anomaly detection model. The processing device 112 may determine a relative location of the reference object using the image quality anomaly detection model. For example, the processing device 112 may designate the center location of the reference object as the relative location of the reference object. Then the processing device 112 may determine whether the image includes a quality anomaly (e.g., the angle anomaly and/or the blocking anomaly) based on the relative location of the reference object.

FIG. 7 is a flowchart illustrating an exemplary process for training an image anomaly detection model for detecting an angle anomaly according to some embodiments of the present disclosure. The process 700 may be executed by the O2O service system 100. For example, the process 700 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process as illustrated in FIG. 7 and described below is not intended to be limiting. In some embodiments, one or more operations of the process 700 may be performed to achieve at least part of operation 504 as described in connection with FIG. 5.

In 702, the processing device 112 (e.g., the acquisition module 402) may obtain a plurality of training samples. In some embodiments, each of the plurality of training samples may include an image capturing a specific scene in the space surrounding and outside of a vehicle. In some embodiments, each of the plurality of training samples may include an image capturing a specific scene in the space inside a vehicle. The plurality of training samples may be obtained by the acquisition module 402 from a storage device (e.g., the storage device 160, the ROM 230, the RAM 240, the storage 390) as described elsewhere in the present disclosure.

In some embodiments, at least a portion of the plurality of training samples include an angle anomaly. As used herein, the angle anomaly of the image may refer to that at least a portion of a scene recorded by the image is not within in a preset field view of a camera caused by the abnormal orientation or offset of the lens (i.e., the shooting angle of the camera) of the camera, for example, shifting upward, shifting downward, shifting to the left, shifting to the right, etc., when the camera collects the training sample. In other words, the angle anomaly of an image may be caused by at least a portion of the field view the camera when the camera collects the image being different from the preset field view the camera. The preset field view the camera may be associated with the position and/or orientation of the lens when the camera is installed.

In 704, the processing device 112 (e.g., the extraction module 406 or the labeling module 404) may determine a location of a reference subject in each of at least a portion of the plurality of training samples. The reference object may be a component or a location of the vehicle (e.g., A-pillar, B-pillar, C-pillar, a neck pillow of a seat, etc.), the skyline, etc. In some embodiments, the processing device 112 may determine the reference object based on the field view of a camera collecting a training sample. For example, the processing device 112 may determine the skyline as the reference object in a training sample if the camera installed inside a vehicle for capturing a specific scene in the space surrounding and outside of the vehicle. As another example, the processing device 112 may determine at least one component of a vehicle installed with the camera as the reference object in a training sample if the camera installed inside a vehicle for capturing a specific scene in the space inside the vehicle. The component of the vehicle may include A-pillar, B-pillar, C-pillar, a neck pillow, etc.

In some embodiments, the processing device 112 may determine the location of the reference subject in a training sample by detecting and/or locating the reference object. For example, the processing device 112 may detect the reference object and describing the reference object using a bounding box enclosing the reference object. The bounding box may be a rectangle box. The processing device 112 may determine the location of the bounding box as the location of the reference object. In some embodiments, the bounding box of the reference object may be marked by a user manually. In some embodiments, the processing device 112 may detect and locate the reference object using an object detecting algorithm as described elsewhere in the present disclosure. The determination of the location of a reference subject in a training sample may be similar to the determination of the location of the reference object in FIG. 6 and may not be described herein.

In 706, the processing device 112 (e.g., the labeling module 404) may determine, based on the location of the reference subject in each of the plurality of training samples, a reference label. As used herein, the reference label of a training sample may be also referred to as an actual label of the training sample. In some embodiments, the reference label of a training sample may indicate whether the training sample includes the angle anomaly. For example, the reference label of a training sample may include a negative sample indicating that the training sample includes the angle anomaly. As another example, the reference label of a training sample may include a positive sample indicating that the training sample does not include the angle anomaly. In some embodiments, the reference label of a training sample may be determined based on a relative location of the reference object. The relative location of the reference object may be determined based on the location of the reference object determined in operation 704. For example, the relative location of the reference object may be determined based on the location of the bounding box enclosing the reference object. As a further example, the relative location of the reference object may be a location of a point on the bounding box or a center point of the bounding box. In some embodiments, the reference label of a training sample may include an ordinate and/or an abscissa of the relative location of the reference object in an image coordinate system. The ordinate of the relative location of the reference object in an image coordinate system may be used to determine whether the lens of a camera shifts downward or upward. The abscissa of the relative location of the reference object in an image coordinate system may be used to determine whether the lens of a camera shifts leftward or rightward. In some embodiments, the reference label may be identified and/or determined by an operator (e.g., a user of the 020 service system 100) manually. For example, the operator may designate a negative or positive sample for a training sample according to the location of the reference object. If the location of the reference object is close to the center of the training sample, the operator may designate a positive sample for the training sample. If the location of the reference object is away from the center of the training sample, the operator may designate a negative sample for the training sample.

In 708, the processing device 112 (e.g., the training module 408) may train a machine learning model based on the each of the plurality of training samples and the corresponding reference label to obtain a trained machine learning model.

In some embodiments, the processing engine 112 may input the each of the plurality of training samples and the corresponding reference label into the machine learning model to train the machine learning model using a model training algorithm. Exemplary model training algorithms may include a gradient descent algorithm, Newton's algorithm & Quasi-Newton algorithms, a conjugate gradient algorithm, a back propagation (BP) algorithm, etc.

In some embodiments, the machine learning model may be constructed based on at least two machine learning models (also referred to as sub-models), for example, a first machine learning model and a second machine learning model. The first machine learning model may be configured to process the each of the plurality of training samples to generate one or more features associated with the reference object (e.g., the skyline) for the each of the plurality of training samples. The first machine learning model may be trained to determine whether the each of the plurality of training samples includes the reference object and extract one or more features associated with the reference object (e.g., the skyline) for a training sample in response to determine that the training sample includes the reference object. In some embodiments, the processing device 112 may detect and/or locate the reference object (e.g., the skyline) in each of the plurality of training samples as described in operation 602 before using the first machine learning model. For example, the processing engine 112 may use a bounding box to mark the skyline. Then, for each of the plurality of training samples, the processing engine 112 may input the training sample with a corresponding bounding box into the first machine learning model to train the first machine model for generating one or more features associated with the skyline. For the each of the plurality of training samples, the second machine learning model may be trained to process the one or more features associated with the skyline of the training sample for generating an estimated label, i.e., the relative location of the reference object. The second machine learning model and the first machine learning model may be trained to make the estimated label and the reference label for each of the plurality of training samples similar or same. The first machine learning model may be constructed based on a CNN model (e.g., an Inception network). The second machine learning model may include a regression model. Exemplary regression models may include a linear regression model, a logistic regression model, a wide model, etc.

In some embodiments, the at least two machine learning models may be trained jointly using a model training algorithm as described elsewhere in the present disclosure, such as a BP algorithm. For example, the first machine learning model (e.g., a CNN model) and the second machine learning model (e.g., a logistic regression model) may be trained jointly by minimizing a joint loss function. Parameters of the first machine learning model and parameters of the second machine learning model may be optimized simultaneously based on the joint loss function. In some embodiments, the parameters of the first machine learning model and the parameters of the second machine learning model may be optimized at partially separately. For example, the first machine learning model may be trained jointly with the second machine learning model first to determine one or more features associated with the reference object (e.g., skyline) of an inputted training sample. The parameters of the first machine learning model may then be frozen and a second machine learning model may be trained to generate the relative location of the reference object (i.e., the estimated label) in a training sample pre-processed by the trained first machine learning model. Training the second machine learning model separately from the first machine learning model may save time and loss a very small performance compared to joint training.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 700. In the storing operation, the processing device 112 may store the plurality of training samples, the label, the sky feature, the relative location of the skyline in any storage device (e.g., the storage device 160) disclosed elsewhere in the present disclosure.

FIG. 8 is a flowchart illustrating an exemplary process 800 for performing an image quality detection according to some embodiments of the present disclosure. The process 800 may be executed by the O2O service system 100. For example, the process 800 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 800. The operations of the illustrated process presented below are intended to be illustrative. In some embodiments, the process 800 may be accomplished with one or more additional operations not described and/or without one or more of the operations discussed. Additionally, the order in which the operations of the process as illustrated in FIG. 8 and described below is not intended to be limiting. In some embodiments, one or more operations of the process 800 may be performed to achieve at least part of operation 506 as described in connection with FIG. 5.

In 802, the processing device 112 (e.g., the determination module 420) may determine one or more features associated with pixels in an image. The image may be as described in connection with 502. The one or more features associated with pixels in an image may also be referred to as image features. Exemplary image features may include a color feature, a texture feature, a shape feature, a spatial relationship feature, etc. The color feature of the image may be described in different spaces (also referred to as color modes), such as an RGB space, an HSV space, a Lab space, a gray space, etc. In some embodiments, the one or more features associated with the pixels (e.g., the color feature) in the image may be described using a gradient feature, a histogram feature, etc. in the gray space, or in the HSV space, or any other space. In some embodiments, the one or more features associated with the pixels (e.g., the color feature) may be described using a hue, a saturation, a value (i.e., lightness), etc., in the HSV space. As used herein, the one or more features associated with the pixels (e.g., the color feature) in the HSV space may be also referred to as HSV features. In some embodiments, the one or more features associated with the pixels (e.g., the color feature) may be described using a chromaticity, a luminosity (or value), etc. in the Lab space.

In some embodiments, the processing device 112 may determine the one or more features associated with the pixels (e.g., a hue, a saturation, a value) in the HSV space by converting the image from the RGB space into the HSV space. In other words, the processing device 112 may determine HSV data based on RGB data of the image, wherein the HSV data includes the hue data, saturation data, and value data. The HSV data may include the hue, the saturation, the value (i.e., lightness) of each of the pixels in an image. The processing device 112 may determine the HSV features based on the HSV data. The processing device 112 may convert the image from the RGB space into the HSV space based on an RGB to HSV conversion algorithm. The RGB to HSV conversion algorithm may provide a transforming relationship between the RGB space and the HSV space. As another example, the processing device 112 may convert the image from the RGB space into the HSV space based on an RGB to HSV color table. The RGB to HSV color table may provide a corresponding relationship between RGB data and HSV data corresponding to different colors.

In some embodiments, the processing device 112 may determine a gradient feature and/or a histogram feature of the image in the gray space, or in the RGB space, or in the HSV space, or any other space. For example, the processing device 112 may determine the histogram feature using a histogram of oriented gradient (HOG) algorithm in the gray space, or in the RGB space, or in the HSV space, or any other space. The processing device 112 may determine the gradient feature based on a directional change in the intensity or color in the image. For example, the processing engine 112 may determine the gradient feature using a Sobel operator. The processing engine 112 may determine the gradient feature based on features in x-direction and y-direction. As used herein, the x-direction may be parallel to the direction of a row of the pixels of the image, and the y-direction may be parallel to the direction of a column of the pixels of the image. The feature in the x-direction and the feature in the y-direction may be determined using the Sobel operator. A Sobel operator for the x-direction and a Sobel operator for the y-direction may be expressed as Equations (1) and (2) respectively:

$$s o b e {l}_{x} = [ \begin{matrix}- 1 & 0 & 1 \\ - 2 & 0 & 2 \\ - 1 & 0 & 1\end{matrix} ] , \qquad ( 1 )$$

$${sobel}_{y} = [ \begin{matrix}- 1 & - 2 & - 1 \\ 0 & 0 & 0 \\ 1 & 2 & 1\end{matrix} ] , \qquad ( 2 )$$

where sobelₓ refers to the sobel operator for the x-direction, and sobel_{y} refers to the sobel operator for the y-direction. The processing engine 112 may determine the feature in the x-direction based on pixel values in the image and the sobel operator for the x-direction. The processing engine 112 may determine the feature in the y-direction based on the pixel values in the image and the sobel operator for the y-direction. The processing engine 112 may determine the gradient feature by performing a weighting operation on the feature in the x-direction and the feature in the y-direction.

In 804, the processing device 112 (e.g., the determination module 420) may determine, based on the one or more features associated with the pixels in the image, a detection result using an image quality detection model. The processing device 112 may input the one or more features associated with the pixels in the image to the image quality detection model. The detection result may be generated by the image quality detection model based on the inputted one or more features. In some embodiments, the detection result may include that the image is normal or anomalous. In some embodiments, the detection result may include that the image includes one of a blur anomaly, a fill light anomaly, an angle anomaly, a spot anomaly, a blocking anomaly, a cast anomaly, a normal state, etc.

The image quality detection model may be configured to evaluate the quality of a specific image captured by a camera. The processing device 112 may evaluate the quality of a specific image by performing an anomaly detection on the specific image using the image quality detection model. For example, the image quality detection model may be used to perform the fill light anomaly and/or the blur anomaly on the image based on the one or more features associated with the pixels in the image. The image quality detection model may be constructed based on a CNN model, a regression model, an SVM model, etc. The CNN model may be configured to determine whether the image includes the blur anomaly. The regression model may be configured to determine whether the image includes the fill light anomaly. The SVM model may be configured to determine whether the image includes the blur anomaly. More descriptions for determining the image quality detection model may be found elsewhere in the present disclosure (e.g., FIG. 9 and the descriptions thereof). For example, the image quality detection model may be obtained by training a machine learning model (e.g., a CNN model, a regression model, an SVM model, etc.) using a plurality of training samples. Each of the plurality of training samples may include a label. In some embodiments, the label may include a positive sample or a negative sample. The positive sample may indicate that a sample is normal. The negative sample may indicate that a sample is anomalous. In some embodiments, the label may include one of the blur anomaly, the fill light anomaly, the angle anomaly, the spot anomaly, the blocking anomaly, the cast anomaly, and the normal state.

In some embodiments, the processing device 112 may determine the detection result based on the HSV features of the image. The processing device 112 may determine based on the HSV features of the image whether the image includes the fill light anomaly. In some embodiments, the processing device 112 may input the HSV features of the image into the image quality detection model. The image quality detection model may generate the detection result based on the input HSV features of the image. In some embodiments, the processing device 112 may determine whether the image includes the fill light anomaly by comparing the value of at least one of the HSV features (also referred to as a color value) with a threshold. For example, the processing device 112 may determine whether the hue of the image is smaller than the threshold. In response to a determination that the hue is smaller than the threshold, the processing device 112 may determine that the fill light anomaly is detected in the image. As another example, the processing device 112 may determine whether the hue is smaller than a first threshold and the value of the image is smaller than a second threshold. In response to a determination that the hue is smaller than the first threshold and the value of the image is smaller than the second threshold, the processing device 112 may determine that a fill light anomaly is detected in the image. As used herein, the fill light anomaly may refer to an anomaly happens when a lamp for filling light cannot fill light when ambient light is not sufficient. Images captured under dim ambient light may be insensitive to colors and not bright enough (e.g., looking like black-and-white images).

In some embodiments, the processing device 112 may determine the detection result based on the HSV features of the image and the gradient feature and/or the histogram feature. The processing device 112 may determine based on the HSV features of the image and the gradient feature and/or the histogram feature of the image whether the image includes at least one of a fill light anomaly, a blur anomaly, a blocking anomaly, a cast color anomaly, or an angle anomaly. In some embodiments, the processing device 112 may input the HSV features of the image and the gradient feature and/or the histogram feature into the image quality detection model. The image quality detection model may generate the detection result based on the input HSV features of the image and the gradient feature and/or the histogram feature.

In some embodiments, the processing device 112 may determine the detection result based on the gradient feature and/or the histogram feature. The processing device 112 may determine based on the gradient feature and/or the histogram feature of the image whether the image includes at least one of a blur anomaly, a blocking anomaly, a cast color anomaly, or an angle anomaly. In some embodiments, the processing device 112 may input the gradient feature and/or the histogram feature into the image quality detection model. The image quality detection model may generate the detection result based on the input gradient feature and/or the histogram feature.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 800. In the storing operation, the processing device 112 may store the one or more features, the detection result in any storage device (e.g., the storage device 160) disclosed elsewhere in the present disclosure.

FIG. 9 is a flowchart illustrating an exemplary process for training an image anomaly detection model according to some embodiments of the present disclosure. The process 900 may be executed by the O2O service system 100. For example, the process 900 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process as illustrated in FIG. 9 and described below is not intended to be limiting. In some embodiments, one or more operations of the process 900 may be performed to achieve at least part of operation 504 as described in connection with FIG. 5.

In 902, the processing device 112 (e.g., the acquisition module 402) may obtain a plurality of training samples. The plurality of training samples may be obtained from the storage device 160, or any other storage device. The plurality of training samples may include normal images and abnormal images. The abnormal images may include at least one of a blur anomaly, a blocking anomaly, a cast color anomaly, an angle anomaly, a spot anomaly, a fill light anomaly, etc. In some embodiments, at least a portion of the plurality of training samples may include at least two anomalies of the blur anomaly, the blocking anomaly, the cast color anomaly, the angle anomaly, the spot anomaly, the fill light anomaly, etc. In some embodiments, a first portion of the plurality of training samples may include the blocking anomaly and a second portion of the plurality of training samples may not include the blocking anomaly. In some embodiments, the first portion of the plurality of training samples may include the blur anomaly and the second portion of the plurality of training samples may not include the blur anomaly. As used herein, a sample including the blur anomaly may be also referred to as a blurred image. A sample not including the blur anomaly may be also referred to as a clear image. In some embodiments, at least a portion of samples including the blur anomaly may be generated using a simulation algorithm. In some embodiments, using the simulation algorithm, the processing device 112 may construct at least a portion of the samples including the blur anomaly based on one or more clear images. For example, the processing device 112 may perform a blur operation on a clear image to obtain an estimated blurred image. Detailed descriptions regarding the determination of the blurred images may be found elsewhere in the present disclosure (e.g., FIG. 10, and the descriptions thereof). In some embodiments, the first portion of the plurality of training samples may include the fill light anomaly and the second portion of the plurality of training samples may not include the fill light anomaly. In some embodiments, the processing device 112 may obtain at least a portion of the first portion of the plurality of training samples including abnormal images from one or more specific cameras whose fill light are not working properly. Detailed descriptions regarding the determination of the one or more cameras whose lamps for filling light are not working properly may be found elsewhere in the present disclosure (e.g., FIG. 11, and the descriptions thereof).

In 904, the processing device 112 (e.g., the labeling module 404) may label each of the plurality of training samples with a label. A label of a training sample may indicate whether the training sample includes a specific image anomaly. For example, a label of a training sample may include a positive sample indicating that the sample is normal. A label of a training sample may include a negative sample indicating that the training sample is anomalous or includes a specific image anomaly (e.g., the blur anomaly, the blocking anomaly, the cast color anomaly, the angle anomaly, the fill light anomaly, etc.). In some embodiments, the label may be a feature vector including one or more elements, wherein each element of the feature vector indicates whether a training sample includes a specific image anomaly. Each element of the feature vector may correspond to a specific image anomaly. Merely by way of example, an element of the feature vector with a value of “1” may indicate that the training sample includes the corresponding image anomaly, and an element with a value of “0” may indicate that the training sample does not include the corresponding image anomaly. As a further example, the feature vector may include a first element, a second element, and a third element. The first element may indicate whether a training sample includes the blocking anomaly. The second element may indicate whether the training sample includes the blur anomaly. The third element may indicate whether a training sample includes the fill light anomaly.

In some embodiments, the plurality of training samples may be used to train an image quality detection model for detecting whether an image includes a blocking anomaly. The plurality of samples may include abnormal samples with the blocking anomaly and normal samples without the blocking anomaly. In some embodiments, the label of a training sample may indicate whether the training sample includes the blocking anomaly. In some embodiments, the label of an abnormal sample may denote the category of the blocking anomaly. For example, the label of an abnormal sample may indicate whether the training sample is captured by a camera whose lens is completely or entirely blocked. As another example, the label of an abnormal sample may indicate whether the training sample is captured by a camera whose lens is partly blocked. As still another example, the label of an abnormal sample may indicate whether the training sample is captured by a camera whose lens shifts up or down which may cause the lens to be blocked partially or entirely by a subject. As a further example, the label of an abnormal sample may indicate whether the training sample is captured by a camera whose lens shifts left or right which may cause the lens to be blocked partially or entirely by a subject.

In some embodiments, the plurality of training samples may be used to train an image quality detection model for detecting whether an image includes the blur anomaly. The plurality of samples may include abnormal samples with the blur anomaly and normal samples without the blur anomaly. The label may indicate whether a training sample includes the blur anomaly. In some embodiments, the plurality of training samples may be used to train an image quality detection model for detecting whether an image includes the fill light anomaly. The plurality of samples may include abnormal samples with the fill light anomaly and normal samples without the fill light anomaly. The label may indicate whether a training sample includes the fill light anomaly.

In some embodiments, at least a portion of the plurality of training samples may be divided into one or more groups, wherein each group includes training samples corresponding to a specific image anomaly. Training samples in the same group may be labeled with the same label. The processing device 112 may label each of the plurality of training samples with the label based on an anomaly of the each of the plurality of training samples. For example, if a training sample includes a blur anomaly, the processing device 112 may designate a label for the training sample indicating that the training sample includes a blur anomaly. If a training sample includes a fill light anomaly, the processing device 112 may designate a label for the training sample indicating that the training sample includes a fill light anomaly. If a training sample includes a blocking anomaly, the processing device 112 may designate a label for the training sample indicating that the training sample includes a blocking anomaly. If a training sample does not include an anomaly, the processing device 112 may designate a label for the training sample indicating that the training sample does not include an anomaly.

In 906, the processing device 112 (e.g., the extraction module 406) may extract one or more features associated with pixels in the each of the labeled training samples. Exemplary features associated with pixels in the each of the labeled training samples may include a color feature, a texture feature, a shape feature, a spatial relationship feature, etc. The color feature of the image may be described in different modes (also referred to as color spaces), such as an RGB mode, an HSV mode, a Lab mode, a gray mode, etc. As used herein, the one or more features associated with the pixels (e.g., the color feature) in the image may be also referred to as image features. In some embodiments, the image features may be described using a gradient feature, a histogram feature, etc. in the gray mode, or in the HSV mode, or any other mode. In some embodiments, the image features associated with the pixels (e.g., the color feature) may be described using a hue, a saturation, a value, etc., in the HSV mode. The extraction of the one or more features associated with pixels in a training sample may be similar to the determination of the one or more features in FIG. 8 and may not be described herein.

In 908, the processing device 112 (e.g., the training module 408) may train a machine learning model to obtain an image quality detection model using the one or more features associated with pixels in the each of the labeled training samples and the label of the each of the plurality of training samples. In some embodiments, the processing engine 112 may input one or more features associated with pixels in the each of the labeled training samples and the label of the each of the plurality of training samples into the machine learning model to train the machine learning model using a model training algorithm. Exemplary model training algorithms may include a gradient descent algorithm, Newton's algorithm & Quasi-Newton algorithms, a conjugate gradient algorithm, a back propagation (BP) algorithm, etc. The machine learning model may be constructed on a regression model, a CNN model, or an SVM model. The label of each of the plurality of training sample determined in operation 904 may be as a desired output of the machine learning model during the training process of the machine learning model. The image features of each of the plurality of training sample may be as an input of the machine learning model during the training process of the machine learning model. The trained machine learning model may be designated as the image quality detection model.

In some embodiments, the machine learning model may be constructed based on multiple sub-models. Each of at least a portion of the multiple sub-models may be trained to detect one of the blocking anomaly, the blur anomaly, the fill light anomaly, the cast color anomaly, the spot anomaly, etc. In some embodiments, the at least a portion of the multiple sub-models trained to detect one of the blocking anomaly, the blur anomaly, the fill light anomaly, the cast color anomaly, the spot anomaly, etc., may share a sub-model for feature extraction based on the inputted image features. In some embodiments, the machine learning model may be constructed based on one single model. The one single model may be trained to detect one single anomaly of the blocking anomaly, the blur anomaly, the fill light anomaly, the cast color anomaly, the spot anomaly, etc.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 900. In the storing operation, the processing device 112 may store security score, the historical data, the transportation service information in any storage device (e.g., the storage device 160) disclosed elsewhere in the present disclosure. In some embodiments, operation 904 may be omitted or integrated into operation 902. In some embodiments, operation 906 may be integrated into operation 908/

FIG. 10 is a flowchart illustrating an exemplary process for determining a plurality of training samples according to some embodiments of the present disclosure. The process 1000 may be executed by the O2O service system 100. For example, the process 1000 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 1000. The operations of the illustrated process presented below are intended to be illustrative. In some embodiments, the process 1000 may be accomplished with one or more additional operations not described and/or without one or more of the operations discussed. Additionally, the order in which the operations of the process as illustrated in FIG. 10 and described below is not intended to be limiting. In some embodiments, one or more operations of the process 1000 may be performed to achieve at least part of operation 902 as described in connection with FIG. 9.

In 1002, the processing device 112 (e.g., the acquisition module 402) may obtain one or more clear images. The one or more clear images may be obtained from the storage device 160, or any other storage device.

In some embodiments, the processing device 112 may determine the one or more clear images from a plurality of images captured by one or more cameras. The processing device 112 may determine whether an image is clear based on a blurring degree of the image and a blur degree threshold or a clarity degree of the image and a clarity degree threshold. For example, the processing device 112 may determine that an image is a clear image in response to a determination that the blur degree of the image is smaller than the blur degree threshold. As another example, the processing device 112 may determine that an image is a clear image in response to a determination that the clarity degree of the image exceeds the clarity degree threshold. The blur degree may be determined based on an image clarity evaluation function. Exemplary image clarity evaluation functions may include a Brenner gradient function, a Tenengrad gradient function, a Laplacian gradient function, an energy gradient function, a Vollrath function, an entropy function, or the like, or any combination thereof. The blur degree threshold and/or the clarity degree threshold may be default settings of the O2O service system 100 or may be adjustable under different situations. For example, the blur degree threshold may be 0.8, or 0.5.

In 1004, the processing device 112 (e.g., the acquisition module 402) may perform a blur operation on the each of the one or more clear images to obtain an estimated blurred image corresponding to each of the one or more clear images. In some embodiments, the processing device 112 may perform the blur operation using an image-blurring filter. The image-blurring filter may be configured to blur an image or at least a portion of the image in various ways. Exemplary image-blurring filters may include a Gaussian blur filter, a selective blur filter, a pixelize filter, a circular motion blur filter, a linear motion blur filter, a zoom motion blur filter, or the like, or a combination thereof. The image-blurring filter may include one or more parameters used to adjust the magnitude (or degree) or type of blurring. For example, the selective blur filter may include a threshold, wherein a difference between pixel values within the threshold are blurred together. As another example, the circular motion blur filter may include a rotational direction and a center, wherein pixels along the rotational direction around the center are blurred.

In some embodiments, the processing device 112 may obtain the estimated blurred image corresponding to a clear image by applying the Gaussian blur filter to the clear image. Using the Gaussian blur filter, the processing device 112 may perform an aligned sampling operation on the clear image and perform a convolve operation on the clear image in a frequency domain using a Gaussian kernel to obtain a blurred image.

In 1006, the processing device 112 (e.g., the acquisition module 402) may determine one or more image features of the estimated blurred image corresponding to each of the one or more clear images. The one or more image features associated with the pixels in the estimated blurred image include a gradient feature, a histogram feature, etc. The extraction of the one or more image features associated with pixels in an estimated blurred image may be similar to the determination of the one or more image features in FIG. 8 and may not be described herein.

In 1008, the processing device 112 (e.g., the acquisition module 402) may designate the estimated blurred image as one of at least a portion of a plurality of training samples in response to a determination that the one or more image features of the estimated blurred image satisfy a condition. In some embodiments, the processing device 112 may determine the estimated blurred image as one of at least a portion of the plurality of training samples in response to a determination that the one or more image features of the estimated blurred image are similar to or same as that of an actual blurred image whose blur degree exceeds the blur threshold. As used herein, an image feature of an estimated blurred image similar to or same as that of an actual blurred image may refer to that a similarity degree between the image features of the estimated blurred image and the actual blurred image exceeds a similarity threshold. The actual blurred image may be captured by a camera working in a normal state.

The processing engine 112 may determine whether the one or more image features of the estimated blurred image are similar to or same as that of an actual blurred image based on a similarity degree between the one or more image features of the estimated blurred image and the one or more features of the actual blurred image. The processing engine 112 may determine that the one or more image features of the estimated blurred image are similar to that of an actual blurred image in response to a determination that the similarity degree is greater than the similarity threshold. In some embodiments, the processing device 112 may determine whether each of the one or more image features (e.g., the gradient feature, the histogram feature) of the estimated blurred image is similar to or same as that of an actual blurred image. The processing device 112 may determine the estimated blurred image as one of at least a portion of the plurality of training samples in response to a determination that each of the one or more image features of the estimated blurred image is similar to or same as that of the actual blurred image. For example, the processing device 112 may determine a first similarity degree between gradient features of the estimated blurred image and the actual blurred image. The processing device 112 may determine a second similarity degree between histogram features of the estimated blurred image and the actual blurred image. The processing device 112 may determine the estimated blurred image as one of at least a portion of the plurality of training samples in response to a determination that the first similarity degree is greater than a first similarity threshold and the second similarity degree is greater than a second similarity threshold. In some embodiments, the processing device 112 may determine a target similarity degree based on the first similarity degree and the second similarity degree. The processing device 112 may determine the estimated blurred image as one of at least a portion of the plurality of training samples in response to a determination that the target similarity degree is greater than a target similarity threshold.

The similarity degree between the one or more image features of the estimated blurred image and the one or more image features of the blurred image may be determined based on a similarity determination algorithm, including a Euclidean distance algorithm, a Manhattan distance algorithm, a Minkowski distance algorithm, a cosine similarity algorithm, a Jaccard similarity algorithm, a Pearson correlation algorithm, or the like, or any combination thereof. In some embodiments, using a similarity determination algorithm, the similarity degree may be defined by a Euclidean distance, a Manhattan distance, a Chebyshev distance, a Minkowski distance, a standardized Euclidean distance, a Mahalanobis distance, a cosine distance, etc.

In some embodiments, the similarity threshold (e.g., the first similarity threshold, the second threshold degree, the target similarity degree) may be set by a user manually. For example, as described in connection with operation 502, a user may input a request for image quality detection. The user may input an expected similarity threshold related to the one or more image features of the estimated blurred image and the one or more image features of the actual blurred image, wherein the expected similarity threshold may be included in the request and transmitted to the processing device 120. The expected similarity threshold may be designated as the similarity threshold. Alternatively, the similarity range may be a default setting of the O2O service system 100 or be determined by a computing device according to different situations.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1000. In the storing operation, the processing device 112 may store the blurred image, the clear image, the one or more features in any storage device (e.g., the storage device 160) disclosed elsewhere in the present disclosure. In some embodiments, operations 1006 and 1008 may be omitted. The processing device 112 may designate the estimated blurred image as one of at least a portion of a plurality of training samples in response to a determination that the blur degree of the estimated blurred image exceeds a threshold (e.g., the blur degree threshold).

FIG. 11 is a flowchart illustrating an exemplary process for determining a plurality of training samples according to some embodiments of the present disclosure. The process 1100 may be executed by the O2O service system 100. For example, the process 1100 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 1100. The operations of the illustrated process presented below are intended to be illustrative. In some embodiments, the process 1100 may be accomplished with one or more additional operations not described and/or without one or more of the operations discussed. Additionally, the order in which the operations of the process as illustrated in FIG. 11 and described below is not intended to be limiting. In some embodiments, one or more operations of the process 1100 may be performed to achieve at least part of operation 902 as described in connection with FIG. 9.

In 1102, the processing device 112 (e.g., the acquisition module 402) may obtain one or more reference images. For example, each of the one or more reference images may include the fill light anomaly. A reference image including a fill light anomaly may be also referred to as a second reference image. The one or more reference images may be obtained from the storage device 160, one or more cameras, or any other storage device.

In some embodiments, the one or more reference images may be determined by a user manually. For example, the user may select one or more images with the fill light anomaly from a plurality of images (also referred to as first images). The plurality of first images may be captured by one or more cameras similar to that camera as described in connection with FIG. 5. The selected images with the fill light anomaly may be designated as the one or more reference images.

In 1104, the processing device 112 (e.g., the extraction module 406) may convert each of the one or more reference images from an RGB space into an HSV space. A reference image may include RGB data describing colors of pixels in the images in the RPG space. The processing device 112 may determine HSV data of the reference image based on the RGB data of the reference image. The HSV data may describe colors of the pixels in the images in the HSV space. For example, the processing device 112 may convert a reference image from the RGB space into the HSV space based on an RGB to HSV conversion algorithm. The RGB to HSV conversion algorithm may provide a transforming relationship between the RGB space and the HSV space. As another example, the processing device 112 may convert a reference image from the RGB space into the HSV space based on an RGB to HSV color table. The RGB to HSV color table may provide a corresponding relationship between RGB data and HSV data corresponding to different colors.

In 1106, the processing device 112 (e.g., the extraction module 406) may determine one or more average features of the one or more reference images in the HSV space. The processing device 112 may determine each of the one or more average features based on HSV features of the one or more reference images. Exemplary HSV features may include a hue, a saturation, a value (i.e., lightness), etc. The processing device 112 may determine the average feature by averaging the HSV features of the one or more reference images. For example, the processing device 112 may determine an average hue of hues of the one or more reference images by averaging the hues of the one or more reference images. As another example, the processing device 112 may determine an average value (i.e., lightness) of the one or more reference images by averaging values (i.e., lightness) of the one or more reference images. Exemplary averages may include arithmetic mean, a median, a geometric median, a geometric mean, a quadratic mean, or the like, or any combination thereof. Detailed descriptions regarding the determination of the HSV features may be found elsewhere in the present disclosure (e.g., FIG. 8, and the descriptions thereof).

In 1108, the processing device 112 (e.g., the acquisition module 402) may obtain, based on the one or more average features, a plurality of candidate images.

In some embodiments, the processing device 112 may select the plurality of candidate images from a plurality of images (also referred to as second images). The plurality of second images may be captured from one or more cameras similar to that camera as described in connection with FIG. 5. In some embodiments, at least a portion of the plurality of first images describe in operation 1102 may be different from the plurality of second images. For each of the plurality of second images, the processing device 112 may determine one or more HSV features including a hue, a saturation, a value, etc. In some embodiments, the processing device 112 may determine whether a specific image from the plurality of images is a candidate image by determining whether at least one of the one or more HSV features of the specific image is within a feature range associated with the one or more average features determined in operation 1106. For example, the processing device 112 may determine that a specific image is a candidate image in response to a determination that the value (i.e., lightness) of the specific image is within a value (i.e., lightness) range from a value (i.e., lightness) threshold to the average value (i.e., lightness) of the one or more reference images. As another example, the processing device 112 may determine that a specific image is a candidate image in response to a determination that the value (i.e., lightness) of the specific image is within the value (i.e., lightness) range and the hue of the specific image is within a hue range from a hue threshold (e.g., 0) to the average hue of the one or more reference images. In some embodiments, the processing device 112 may determine whether a specific image from the plurality of second images is a candidate image based on the one or more HSV features of the specific image and the one or more average HSV features. For example, the processing device 112 may determine that a specific image is a candidate image in response to a determination that the value of the specific image is smaller than the average value determined in operation 1106. As another example, the processing device 112 may determine that a specific image is a candidate image in response to a determination that the value of the specific image is smaller than the average value determined in operation 1106 and the hue of the specific image is smaller than the average hue determined in operation 1106. As used herein, an average feature may be also referred to as a feature threshold.

In 1110, the processing device 112 (e.g., the determination module 412) may determine one or more specific cameras whose lamps are in breakdown based on the plurality of candidate images. The processing device 112 may determine the one or more specific cameras which collect the plurality of candidate images. Each of the plurality of candidate images may include camera information identifying a camera capturing the each of the plurality of candidate images. For example, the camera information may be a camera identity used for camera identification. For each of the plurality of candidate images, the processing device 112 may obtain a camera identity of a camera based on the candidate image and determine a camera with the camera identity to be one of the one or more specific cameras. In some embodiments, the processing device 112 and/or related personnel (e.g., repair personnel, an engineer, etc.) may further determine whether the lamp of each of the one or more specific cameras is in a breakdown. For example, the processing device 112 and/or related personnel may obtain one or more test images captured by each of the specific cameras. At least a portion of the one or more test images may be collected by a specific camera when a vehicle where the specific camera is installed travels from a place with good light (e.g., outside a tunnel) to a place with poor light (e.g., inside the tunnel) with respect to the place with good light. The processing device 112 and/or related personnel may determine whether the lamp of each of the one or more specific cameras is in breakdown based on a color or brightness of each of the at least a portion of the test images. For example, if a difference between the brightness and/or colors of test images collected by the specific camera or the brightness and/or colors of test images change sharply or obviously when the vehicle travels from a place with good light (e.g., outside a tunnel) to a place with poor light (e.g., inside the tunnel) with respect to the place with good light exceeds a threshold, the processing device 112 and/or a related personnel may determine that the lamp of each of the one or more specific cameras is in breakdown.

In 1112, the processing device 112 (e.g., the acquisition module 402) may obtain at least a portion of the plurality of training samples from the one or more specific cameras. In some embodiments, the processing device 112 may determine a plurality of images (also referred to as third images) captured by each of the one or more specific cameras as the at least a portion of the plurality of training samples. In some embodiments, the plurality of training samples may include at least a portion of the one or more reference images obtained in operation 1102. In some embodiments, the plurality of training samples may include at least a portion of the plurality of candidate images obtained in operation 1108. Similar to the camera described in FIG. 5, each of the one or more specific cameras may be configured to perform surveillance of an AOI or an object of interest within a scope of the camera. In some embodiments, each of the one or more specific cameras may be mounted on a vehicle (e.g., the vehicle 150), for example, inside and/or outside of the vehicle and configured to monitor an environment associated with the vehicle. Each of the one or more specific cameras may capture a set of consecutive images when performing surveillance. A set of consecutive images may also be referred to as an image sequence including a plurality of frames. The processing device 112 may obtain the at least a portion of the plurality of training samples from the one or more sets of consecutive images. For a set of consecutive images, the processing device 112 may determine consecutive images with a sharp change of brightness between the consecutive images from the set of consecutive images as the at least a portion of the plurality of training samples. As used herein, consecutive images with a sharp change of brightness may refer to that a difference between the brightness of consecutive images exceeds a threshold.

In some embodiments, the processing device 112 may determine consecutive images with a sharp change of brightness to be positive training samples if the consecutive images are collected when the light intensity changes sharply. The processing device 112 may determine consecutive images with a weak or no change of brightness to be negative training samples if the consecutive images are collected when the light intensity changes sharply. In some embodiments, the training samples may be captured when the light intensity changes sharply, for example, when a vehicle travels into a tunnel.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1100. In the storing operation, the processing device 112 may store the one or more consecutive images, the HSV feature, the camera identity in any storage device (e.g., the storage device 160) disclosed elsewhere in the present disclosure.

FIG. 12 is a flowchart illustrating an exemplary process for determining a detection result of an image according to some embodiments of the present disclosure. The process 1200 may be executed by the O2O service system 100. For example, the process 1200 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 1200. The operations of the illustrated process presented below are intended to be illustrative. In some embodiments, the process 1200 may be accomplished with one or more additional operations not described and/or without one or more of the operations discussed. Additionally, the order in which the operations of the process as illustrated in FIG. 12 and described below is not intended to be limiting.

In 1202, the processing device 112 (e.g., the acquisition module 410) may obtain an image acquired by a camera. The image may be similar to the image in FIG. 5 and may not be described herein. Similar to the image in FIG. 5, the image may be obtained from one or more components of the O2O service system 100, such as a storage device (e.g., the storage device 160, the storage of the computing device 200, the storage 390), the requester terminal 130, the provider terminal 140, the camera installed with the vehicles 150, or the like, or any combination thereof.

In 1204, the processing device 112 (e.g., the determination module 420) may determine, based on a target threshold of an image quality detection model, a detection result of the image using the image quality detection model. The image quality detection model may be obtained from the storage device 160, the storage module 440, the storage module 416 or any other storage device. In some embodiments, the image quality detection model may be implemented on a computing device (e.g., the processing device 112, the computing device 200, the mobile device 300, etc.) as an application. The image quality detection model may be configured to evaluate the quality of a specific image captured by a camera based on the target threshold. For example, the processing device 112 may perform a color cast anomaly detection on the specific image using the image quality detection model with the target threshold. In other words, the image quality detection model may be used to detect whether a specific image includes a color cast anomaly. The color cast anomaly of an image may refer to that a difference between the color of a scene (e.g., an object) presented in the image and the actual color of the scene exceeds a threshold. The color cast anomaly may happen, for example, when the lens of the camera is damaged, or when the lens of the camera is covered by a colored membrane or a filter, etc. In some embodiments, the image quality detection model may be configured to determine whether a specific image is anomalous. A detection result of the specific image produced by the image quality detection model with the target threshold may include that the specific image is anomalous or normal. In some embodiments, the image quality detection model may be configured to determine whether a specific image includes the color cast anomaly. A detection result of the specific image produced by the image quality detection model may include the color cast anomaly or a normal result. In some embodiments, the image quality detection model may be used to determine and/or output the color cast factor of a specific image. For example, the image quality detection model may be configured to provide an algorithm for determining the color cast factor of the specific image. The color cast factor of an image may be used to denote a difference between the color of a scene (e.g., an object) presented in the image and the actual color of the scene. The greater the color cast factor of the image is, the greater the difference may be, and the higher the possibility that the image includes a cast color anomaly may be. In some embodiments, the image quality detection model may be configured to determine whether the image is anomalous by comparing the color cast factor of the image with the target threshold. The image quality detection model may be configured to determine that the inputted image is anomalous in response to a determination that the color cast factor of the image is greater than the target threshold. The image quality detection model may be configured to determine that the inputted image is normal in response to a determination that the color cast factor of the image is less than the target threshold.

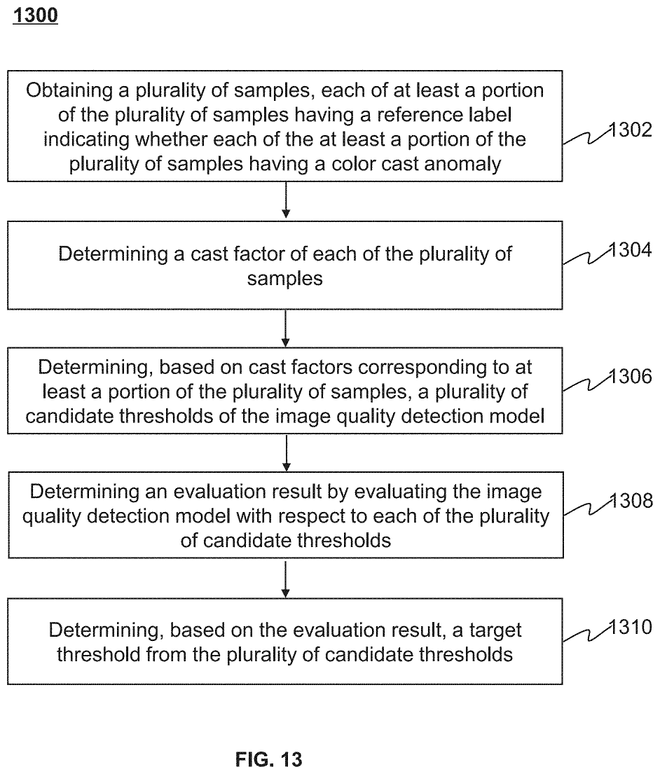

In some embodiments, the processing device 112 may determine whether the image obtained in 1202 includes a color cast anomaly by determining, using the image quality detection model, the color cast factor and comparing the color cast factor of the image with the target threshold. The processing device 112 may determine that the image obtained in 1202 includes the color cast anomaly in response to a determination that the color cast factor of the image is greater than the target threshold. The processing device 112 may determine the color cast factor of the image in LAB space. For example, the processing device 112 may determine an average chromaticity of the image in the LAB space. The processing device 112 may determine, based on the average chromaticity, a color cast factor of the image. Detailed descriptions regarding the determination of the color cast factor may be found elsewhere in the present disclosure (e.g., FIG. 13, and the descriptions thereof).

In some embodiments, the processing device 112 or any other processor different with the processing device 112 may determine the target threshold based on a plurality of samples, each of at least a portion of the plurality of samples having a reference label indicating that each of the at least a portion of the plurality of samples having a color cast anomaly. For example, the processing device 112 or any other processor different from the processing device 112 may determine a color cast factor for each of the plurality of samples. The processing device 112 or any other processor different with the processing device 112 may determine, based on color cast factors corresponding to at least a portion of the plurality of samples, a plurality of candidate thresholds of the image quality detection model. The processing device 112 or any other processor different with the processing device 112 may determine an evaluation result by evaluating the image quality detection model with respect to each of the plurality of candidate thresholds based on the plurality of samples. The processing device 112 or any other processor different from the processing device 112 may determine, based on the evaluation result, the target threshold from the plurality of candidate thresholds. Detailed descriptions regarding the determination of the target threshold may be found elsewhere in the present disclosure (e.g., FIG. 13, and the descriptions thereof).

In 1206, in response to a determination that the detection result includes a color cast anomaly, the processing device 112 (e.g., the generation module 430) may generate a strategy in response to the color cast anomaly.

The strategy may include generating an alert for reminding a related personnel (e.g., a driver, a passenger, an engineer, a repair personnel, etc.) associated with the camera, informing a related personnel (e.g., a driver, a passenger, an engineer, a repair personnel, etc.) associated with the camera to examine and/or repair the camera, a suggestion for solving the color cast anomaly, etc. In some embodiments, the processing device 112 may generate a signal including the strategy and detection result and transmit the signal to a terminal (e.g., a mobile terminal) associated with the related personnel. The signal may be also configured to direct the terminal to display the strategy and/or the detection result to the related personnel. For example, the signal may include the alert for reminding and/or informing the driver that lens of the camera is damaged, or the lens of the camera is covered by a colored membrane or a filter, etc. As another example, the signal may include the suggestion for solving the color cast anomaly, advising the driver to repair lens of the camera, or remove the colored membrane or the filter covering the lens of the camera.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1200. In the storing operation, the processing device 112 may store security score, the historical data, the transportation service information in any storage device (e.g., the storage device 160) disclosed elsewhere in the present disclosure.

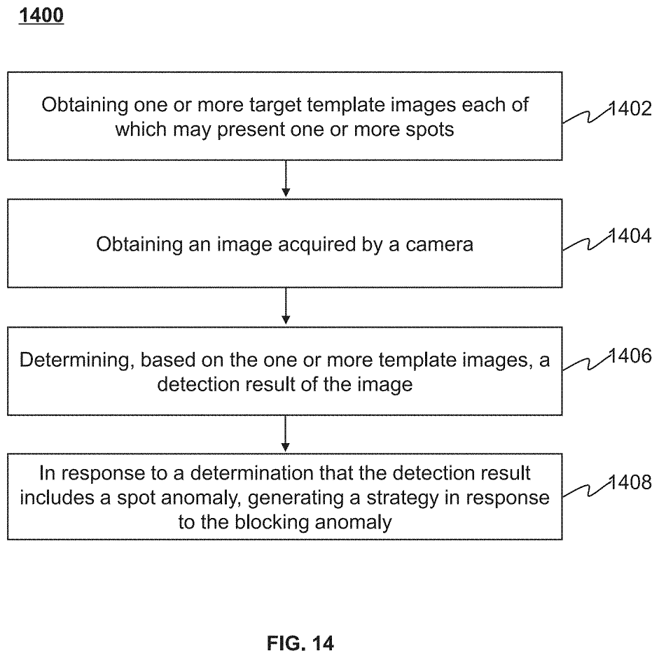

FIG. 13 is a flowchart illustrating an exemplary process for determining a target threshold according to some embodiments of the present disclosure. The process 1300 may be executed by the O2O service system 100. For example, the process 1300 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 1300. The operations of the illustrated process presented below are intended to be illustrative. In some embodiments, the process 1300 may be accomplished with one or more additional operations not described and/or without one or more of the operations discussed. Additionally, the order in which the operations of the process as illustrated in FIG. 13 and described below is not intended to be limiting. In some embodiments, one or more operations of the process 1300 may be performed to achieve at least part of operation 1204 as described in connection with FIG. 14.

In 1302, the processing device 112 (e.g., the acquisition module 402) may obtain a plurality of samples, each of at least a portion of the plurality of samples having a reference label indicating whether each of the at least a portion of the plurality of samples having a color cast anomaly. Each of the plurality of samples may include an image captured by a camera. The plurality of samples may be obtained from the storage device 160, the storage module 416, one or more cameras, or any other storage device.

In some embodiments, the plurality of samples may be selected by a user manually. For example, the user may determine a plurality of images captured by one or more cameras. And the user may select a first portion of the plurality of images with the color cast anomaly. The user may select a second portion of the plurality of images without the color cast anomaly. The processing device 112 or the user may determine the reference label for each of the first portion of the plurality of images with the color cast anomaly and the second portion of the plurality of images without the color cast anomaly. For example, if an image includes the color cast anomaly, the processing device 112 or the user may label the image with the reference label as a negative sample. If an image does not include the color cast anomaly, the processing device 112 or the user may label the image with the reference label as a positive sample. The first portion and/or the second portion of the plurality of images with reference labels may be designated as the plurality of samples.

In 1304, the processing device 112 (e.g., the determination module 412) may determine a color cast factor of each of the plurality of samples. In some embodiments, the processing device 112 may determine the color cast factor of a specific sample according to operations A1-A4. In operation A1, the processing device 112 may convert a color space of the specific sample from an RGB space into a LAB space. In some embodiments, the processing device 112 may convert the color space of the specific sample from the RGB space into an XYZ space based on Equations (3) and (4) as follows:

$$\{ \begin{matrix}R = gamma ( \frac{r}{255.0} ) \\ G = gamma ( \frac{g}{255.0} ) \\ B = gamma ( \frac{b}{255.} )\end{matrix} , \qquad ( 3 )$$

$$\{ \begin{matrix}X = R \times 0.4124 + G \times 0.3576 + B \times 0.1805 \\ Y = R \times 0.2126 + G \times 0.7152 + B \times 0.0722 \\ Z = R \times 0.0193 + G \times 0.1192 + B \times 0.9505\end{matrix} , \qquad ( 4 )$$

where r, g, b denote three original color components (chromaticity coordinates) in the RGB space, r refers to an original red component, g refers to an original green component, b refers to an original blue component, R, G, B refers to three Gamma corrected color components corresponding to r, g, b, respectively, R refers to a Gamma corrected red component, G refers to a Gamma corrected green component, B refers to a Gamma corrected blue component, gamma ( ) refers to a gamma function used for Gamma correction, which may increase image contrast X, Y, Z denote three ideal colors in the XYZ space, the three ideal colors (or imaginary colors) being configured to determine spectral tristimulus values and r, g, b in the RGB space become positive values. The gamma function may be expressed as Equation (5) as follows:

$$gamma ( x ) = \{ \begin{matrix}{( \frac{x + 0.055}{1.055} )}^{2.4} & x > 0.04045 \\ \frac{x}{12.92} & otherwise\end{matrix} , \qquad ( 5 )$$

where x refers to an input of the gamma function, such as

$$\frac{r}{255.0} , \frac{g}{255.0} , or \frac{r}{255.0} .$$

The processing device 112 may then convert the color space of the specific sample from the XYZ space into the LAB space based on the following Equation (6) as follows:

$$\{ \begin{matrix}{L}^{*} = 116 f ( \frac{Y}{Yn} ) - 16 \\ {a}^{*} = 500 [ f ( \frac{X}{Xn} ) - f ( \frac{Y}{Yn} ) ] , \\ {b}^{*} = 200 [ f ( \frac{Y}{Yn} ) - f ( \frac{Z}{Zn} ) ]\end{matrix} \qquad ( 6 )$$

where L*, a*, b* refer to three channel components in the LAB space, L* refers to the lightness from black (0) to white (100), a* refers to colors from green (−) to red (+), b* refers to colors from blue (−) to yellow (+), Xn, Yn, Zn are 95.047, 100.0, and 108.883, respectively, and f ( ) may be expressed as Equation (7) as follows:

$$f ( t ) = \{ \begin{matrix}{t}^{\frac{1}{3}} & if t > {( \frac{6}{29} )}^{3} \\ \frac{1}{3} {( \frac{29}{6} )}^{2} t & otherwise\end{matrix} , \qquad ( 7 )$$

where t refers to an input of the function, such as,

$$\frac{X}{X n} , \frac{Y}{Y n} , or \frac{Z}{Z n} .$$

In operation A2, the processing device 112 (e.g., the determination module 412) may determine an average chromaticity of the specific sample in the LAB space. For a sample (i.e., an image), the average chromaticity may be a feature representing the color of the sample. The average chromaticity may be determined based on at least a portion of the three channel components in the LAB space. For example, the processing device 112 may determine the average chromaticity of the specific sample based on Equations (8) to (10) as follows:

$${d}_{a} = \frac{{\sum }_{i = 1}^{M} {\sum }_{j = 1}^{N} {a}^{*}}{M N} , \qquad ( 8 )$$

$${d}_{b} = \frac{{\sum }_{i = 1}^{M} {\sum }_{j = 1}^{N} {b}^{*}}{M N} , \qquad ( 9 )$$

$$D = \sqrt{{d}_{a}^{2} + {d}_{b}^{2}} , \qquad ( 10 )$$

where dₐ refers to an average chromaticity corresponding to a*, d_{b} refers to a average chromaticity corresponding to b*, D refers to the average chromaticity of the sample, M refers to the number of rows in an array representing pixels in the sample, i.e., a width of the sample (image) in pixels, N refers to the number of columns in the array, i.e., a height of the sample (image) in pixels, i refers to the row of a pixel in the array, j refers to the column of a pixel in the array. In operation A3, the processing device 112 (e.g., the determination module 412) may determine, based on the average chromaticity, a color cast factor of the specific sample. In some embodiments, the processing device 112 may first determine a color center distance for the specific sample. For example, the processing device 112 may determine the color center distance of the specific sample based on the following Equations (11) to (13):

$${M}_{a} = \frac{{\sum }_{i = 1}^{M} {\sum }_{j = 1}^{N} {( {a}^{*} - {d}_{a} )}^{2}}{M N} , \qquad ( 11 )$$

$${M}_{b} = \frac{{\sum }_{i = 1}^{M} {\sum }_{j = 1}^{N} {( {b}^{*} - {d}_{b} )}^{2}}{M N} , \qquad ( 12 )$$

$$CCD = \sqrt{{M}_{a}^{2} + {M}_{b}^{2}} , \qquad ( 13 )$$

where Mₐ refers to a color center distance corresponding to a*, M_{b} refers to a color center distance average chromaticity corresponding to b*, CCD refers to the color center distance of the sample. In operation A4, the processing device 112 may then determine, based on the average chromaticity and the color center distance, the color cast factor of the specific sample. For example, the processing device 112 may determine the color factor of the specific sample based on Equation (14) as follows:

$$K = \frac{D}{C C D} , \qquad ( 14 )$$

where K refers to the color cast factor. K may be configured to determine whether an image includes a color cast. For example, K may be configured to evaluate the degree of a color cast.

In 1306, the processing device 112 (e.g., the determination module 412 or the evaluation module 414) may determine, based on color cast factors corresponding to at least a portion of the plurality of samples, a plurality of candidate thresholds of the image quality detection model. A candidate threshold associated with the image quality detection model may be configured to determine whether an image has the color cast under the candidate threshold. For example, if a color cast factor of an image determined using the image quality detection model is greater than the candidate threshold, the processing device 112 may determine that the image is anomalous, i.e., including the cast anomaly with respect to the candidate threshold.

In some embodiments, the processing device 112 may determine at least a portion of the plurality of candidate thresholds based on the color cast factor determined in operation 1306. For example, the processing device 112 may determine a portion or all of the plurality of candidate thresholds based on the color cast factors corresponding to at least a portion of the plurality of samples. Further, the processing device 112 may designate each of the color cast factors corresponding to at least a portion of the plurality of samples as one of the plurality of candidate thresholds. As a further example, the processing device 112 may rank the color cast factors corresponding to each of the plurality of samples (e.g., in an ascending order or a descending order). The processing device 112 may determine a portion or all of the plurality of candidate thresholds based on the ranked color cast factors of the plurality samples. A color cast factor ranked as, e.g., the top, the bottom, the medium of the ranked color cast factors may be designated as a candidate threshold. As still another example, the processing device 112 may designate one or more color cast factors of at least a portion of the plurality samples within a certain range as one or more candidate thresholds. In some embodiments, the processing device 112 may designate the color cast factor corresponding to each of the plurality of samples as one of the plurality of candidate thresholds. In some embodiments, at least a portion of the plurality of candidate thresholds may be set by a user or according to a default setting of the O2O service system 100.

In 1308, the processing device 112 (e.g., the evaluation module 414) may determine an evaluation result by evaluating the image quality detection model with respect to each of the plurality of candidate thresholds. In some embodiments, the processing device 112 may evaluate the image quality detection model with respect to each of the plurality of candidate thresholds according to one or more evaluation indexes. The evaluation result may be denoted by one or more values of the one or more evaluation indexes. Exemplary evaluation indexes of the image quality detection model may include a precision rate, a recall rate, an accuracy rate, an error rate, a sensitive, a sensitive, a receiver operating characteristic (ROC), an area under ROC curve (AUC), a Gini coefficient, or the like, or any combination thereof. An evaluation index may be used to measure and/or indicate performance of the image quality detection model with respect to a candidate threshold on cast anomaly detection. For example, the AUC of the image quality detection model may be defined by a probability that when the image quality detection model is used for color cast anomaly detection, a random positive sample is ranked above a random negative sample. The greater the value of AUC of the image quality detection model with respect to a candidate threshold, the greater the accuracy of the image quality detection model may be.

The processing device 112 may determine the value of an evaluation index of the image quality detection model with respect to a specific candidate threshold based on the plurality of samples. For example, the processing device 112 may determine the value of the evaluation index based on the specific candidate threshold and the color cast factor corresponding to each of the plurality of samples. For the specific candidate threshold, the processing device 112 may determine an estimated label for each of the plurality of samples by comparing the specific candidate threshold and the color cast factor corresponding to each of the plurality of samples. The estimated label of a sample may include a positive sample or a negative sample determined based on the specific candidate threshold. The positive sample may indicate that a sample is normal, that is, the sample does not include a color cast anomaly. The negative sample may indicate that a sample is anomalous, that is, the sample includes a color cast anomaly. The processing device 112 may determine the estimated label of a sample as a positive sample if the color cast factor corresponding to the sample is smaller than or equal to the specific candidate threshold. The processing device 112 may determine the estimated label of a sample as a negative sample if the color cast factor corresponding to the sample is greater than the specific candidate threshold. The processing device 112 may determine an evaluation index corresponding to the specific candidate threshold based on the estimated label and a reference label corresponding to each of the plurality of samples. The reference label of a sample may be also an actual label of the sample indicating whether the sample includes the cast color anomaly. In some embodiments, the evaluation index with respect to a candidate threshold may be determined based on a confusion matrix for the image quality detection model. The confusion matrix may be used to describe the performance of the image quality detection model on the plurality of samples with a fixed threshold (e.g., a candidate threshold). For a specific candidate threshold, the processing device 112 may determine the confusion matrix based on estimated labels of the plurality of samples corresponding to the specific candidate threshold and the reference labels of the plurality of samples. For a specific candidate threshold, the processing device 112 may divide the plurality of samples into four sets and determine the confusion matrix based on the numbers of samples in each of the four sets. For each of the plurality of samples, the processing device 112 may determine a set only to which the sample belongs to based on the relationship between the estimated label and the reference label. The four sets may include a true positive (TP) set, a true negative (TN) set, a false positive (FP) set, and a false negative (FN) set. For example, if the estimated label and the reference label both indicate the sample is a positive sample, the processing device 112 may determine that the sample belongs the TP set. If the estimated label and the reference label both indicate the sample is a negative sample, the processing device 112 may determine that the sample belongs the TN set. If the estimated label indicates the sample is a positive sample while the reference label indicates the sample is a negative sample, the processing device 112 may determine that the sample belongs the FP set. If the estimated label indicates the sample is a negative sample while the reference label indicates the sample is a positive sample, the processing device 112 may determine that the sample belongs the FN set. The processing device 112 may determine the confusion matrix based on the numbers of samples in each of the four sets as below:

| | Estimated label: | Estimated label: | |
|---|---|---|---|
| | negative | positive | Count |
| Reference label: | TN = e | FP = f | e + f |
| negative | | | |
| Reference label: | FN = g | TP = h | g + h |
| positive | | | |
| Count | e + g | f + h | |

In the confusion matrix, “e” refers to the number or count of samples belonging the TN set, “f” refers to the number or count of samples belonging the FP set, “g” refers to the number or count of samples belonging the FN set, “h refers to the number of the TP set. The total number of the plurality of sample may be referred to as TT. In some embodiments, the processing device 112 may determine one or more evaluation indexes based on the confusion matrix. For example, the processing device 112 may determine the precision of the image quality detection model according to the Equation (12) as below:

$$P = \frac{h}{f + h} , \qquad ( 12 )$$

where P refers to precision. The precision may indicate how often the image quality detection model is correct when it predicts a positive sample (outputs an estimated label of positive). As another example, the processing device 112 may determine the recall of the image quality detection model according to the Equation (13) as below:

$$R = \frac{h}{h + g} , \qquad ( 13 )$$

where R refers to the recall. The recall may indicate how often the image quality detection model is correct for a sample with a reference label of positive. As still another example, the processing device 112 may determine the accuracy of the image quality detection model according to the Equation (14) as below:

$$accuracy = \frac{e + h}{e + g + f + h} , \qquad ( 14 )$$

where accuracy refers to the accuracy. The accuracy may indicate how often the image quality detection model is correct.

In 1310, the processing device 112 (e.g., the determination module 412) may determine based on the evaluation result, the target threshold from the plurality of candidate thresholds. In some embodiments, the processing device 112 may determine multiple evaluation results each of the which corresponds to a candidate target. In some embodiments, the processing device 112 may compare the evaluation results corresponding to the plurality of candidate thresholds. In some embodiments, the evaluation result corresponding to each of the plurality of candidate thresholds may include a value of one single evaluation index. The plurality of candidate thresholds may include multiple values of the one single evaluation index. The processing device 112 may compare the multiple values of the one single evaluation index of the image quality detection model with respect to the plurality of candidate thresholds. The processing device 112 may designate a candidate threshold that corresponds to the maximum or minimum among the multiple values of the one single evaluation index of the image quality detection model with respect to the plurality of candidate thresholds as the target threshold. As another example, the processing device 112 may determine at least two candidate thresholds from the plurality of candidate thresholds. The multiple values of the one single evaluation index of the image quality detection model corresponding to the at least two candidate thresholds may be greater than or smaller than values of the one single evaluation index corresponding to other candidate thresholds of the plurality of candidate thresholds. The processing device 112 may designate an average of the at least two candidate thresholds as the target threshold.

In some embodiments, the evaluation result corresponding to each of the plurality of candidate thresholds may include values of at least two evaluation indexes. The processing device 112 may determine an intermediate value of the at least two evaluation indexes corresponding to each of the plurality of candidate thresholds. For example, the intermediate value of the at least two evaluation indexes may be a weighted value determined by weighting the value of each of the at least two evaluation indexes based on a weight of each of the at least two evaluation indexes. Weights of the one or more evaluation indexes may be default settings of the O2O service system 100 or may be adjustable under different situations. As another example, the intermediate value of the at least two evaluation indexes may be an average value of the values of the at least two evaluation indexes. The processing device 112 may compare multiple intermediate values of the at least two evaluation indexes of the image quality detection model with respect to the plurality of candidate thresholds. The processing device 112 may designate a candidate threshold that corresponds to the maximum or minimum among the multiple intermediate values of the at least two evaluation indexes of the image quality detection model with respect to the plurality of candidate thresholds as the target threshold.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1300. In the storing operation, the processing device 112 may store the evaluation index, the reference label, the estimated label in any storage device (e.g., the storage device 160) disclosed elsewhere in the present disclosure.

FIG. 14 is a flowchart illustrating an exemplary process for spot anomaly detecting of an image according to some embodiments of the present disclosure. In some embodiments, process 1400 may be executed by the O2O service system 100. For example, the process 1400 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 1400. The operations of the illustrated process presented below are intended to be illustrative. In some embodiments, the process 1400 may be accomplished with one or more additional operations not described and/or without one or more of the operations discussed. Additionally, the order in which the operations of the process as illustrated in FIG. 14 and described below is not intended to be limiting.

In 1402, the processing device 112 (e.g., the acquisition module 410) may obtain one or more target template images each of which may present one or more spots. As used herein, a spot presented in a target template image may be referred to as a region including one or more specific characteristics, such as a shape, a size, an arrangement shape, an orientation, etc. Exemplary shapes of a spot may include a circle, an oval, a polygon, etc. The size of a spot or a region corresponding to the spot may be defined by a diameter, a perimeter, an area, etc. Exemplary arrangement shapes of spots arranged in a target template image may include an umbrella arrangement, an arrangement in a row, arrangement in disorder, etc. A target template image may be an image (e.g., a binary image) presenting the one or more spots with same or similar characteristics. As used herein, similar characteristics (e.g., size, shape, etc.) may refer to that a similarity degree between the characteristics of two or more spots exceeds a similarity threshold (e.g., 0.9, 0.8, etc.). For example, the one or more spots in the same target template image may have a similar or same shape, such as a circle, or an oval, or a polygon, etc. The one or more spots in the same target template image may have similar sizes, e.g., within a specific diameter range (e.g., 0-0.5 centimeter). In some embodiments, the one or more target template images may present the one or more spots with different characteristics in different target template images. As used herein, different characteristics (e.g., size, shape, etc.) of two spots in two different target template images may refer to that a similarity degree between the characteristics of the two spots is less than a similarity threshold (e.g., 0.9, 0.8, etc.). For example, the spots in one target template image may have different shapes and/or different sizes from the spots in another target template image.

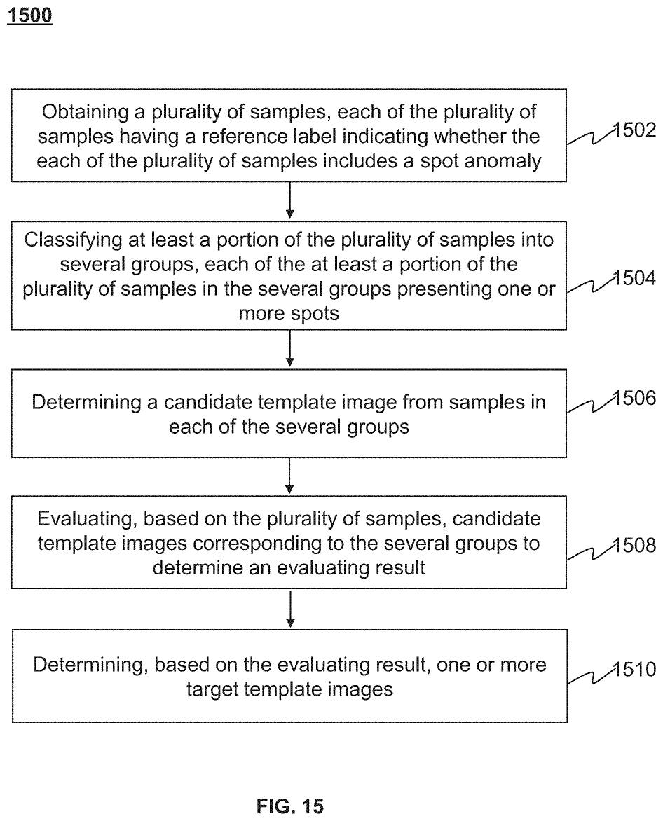

In some embodiments, the one or more target template images may be obtained from one or more components of the O2O service system 100, such as a storage device (e.g., the storage device 160, the storage of the computing device 200, the storage 390), the requester terminal 130, the provider terminal 140, the camera installed with the vehicles 150, or the like, or any combination thereof. For example, the one or more target template images may be obtained from the storage device 160 in response to a receipt of a request for spot anomaly detection input by a user (e.g., a driver, repair personnel, etc.) via a terminal. In some embodiments, a target template image may be determined by a processor same as or different from the processing device 112 (e.g., the processing device 112, a processor of the provider terminal 140, etc.). The processor may obtain a plurality of samples, each of the plurality of samples having a reference label indicating that each of the plurality of samples presenting one or more spots or having no spot. The processor may classify at least a portion of the plurality of samples into several groups, each of the at least a portion of the plurality of samples in the several groups presenting one or more spots. The processor may determine one or more candidate template images from samples in each of the several groups. The processor may evaluate, based on the plurality of samples, each of the one or more candidate template images to determine an evaluating result with respect to each of the one or more candidate template images for each of the several groups. The processor may determine, based on the evaluating result, one of the one or more target template images from the one or more candidate template images for each of the several groups. Detailed descriptions regarding the determination of the one or more target template images may be found elsewhere in the present disclosure (e.g., FIG. 15, and the descriptions thereof).

In 1404, the processing device 112 (e.g., the acquisition module 410) may obtain an image acquired by a camera. The image may be obtained as similar to the image in FIG. 5 and may not be described herein. For example, the image may be obtained from one or more components of the O2O service system 100, such as a storage device (e.g., the storage device 160, the storage of the computing device 200, the storage 390), the requester terminal 130, the provider terminal 140, the camera installed with the vehicles 150, or the like, or any combination thereof. As another example, the image may be collected by a camera installed inside a vehicle when monitoring an area inside or outside the vehicle within a scope of the camera.

In 1406, the processing device 112 (e.g., the determination module 420) may determine, based on the one or more template images, a detection result of the image. In some embodiments, the detection result of the image may include that the image is anomalous or normal. In some embodiments, the detection result of the image produced based on the one or more target template images may include a spot anomaly or a normal result. The spot anomaly of a specific image may refer to that the specific image includes multiple regions the image features of (e.g., color and/or gray value, a texture feature, etc.) each of which changing sharply with respect to image features of surrounding regions and the characteristics of each of which satisfying a criteria (e.g., the size of a region may be smaller than or equal to a predefined threshold). The count or number of the multiple regions or spots in a specific image including the spot anomaly may exceed a count threshold (e.g., 5, 10, 15, etc.). The spot anomaly of a specific image may happen when the lens of the camera is blocked by multiple spots, such as stains when collecting the specific image. For example, the spots may be on a windshield of a vehicle or on a protective film attached to the windshield of the vehicle the camera is mounted on. As another example, the spots may be on the lens of the camera or on a protective film attached to the lens of the camera.

In some embodiments, the processing device 112 may determine the detection result of the image by comparing the image with each of the one or more target template images. For example, the processing device 112 may determine the detection result of the image by performing a template matching algorithm between each of the one or more target template images and the image. Using a template matching algorithm, the processing device 112 may determine whether the image is matched with one of the one or more target template images. In response to a determination that the image is matched with one of the one or more target template images, the processing device 112 may determine that the image include the spot anomaly. The template matching algorithm may be configured to identify one or more parts of a specific image (or multiple images) that matches a given image pattern. The given image pattern may be a part or a region of one of the one or more target template images or the entire target template image. The processing device 112 may search for one or more areas of the specific image that match (are similar to) at least one target template image of the one or more target template images using the template matching algorithm. Exemplary template matching algorithms may include a Navie template matching (NTM) algorithm, an image correlation matching (ICM) algorithm, a pattern correlation image (PCI) algorithm, a grayscale based matching (GBM) algorithm, an edge-based Matching (EBM) algorithm, or the like, or any combination thereof. In some embodiments, as the one or more spots presented in an image to be detected orientate differently, a GBM algorithm may be used. The GBM algorithm may allow searching for pattern occurrences regardless of orientation. The GBM algorithm may allow spots in different orientations to be identified. Exemplary GBM algorithms may include a mean absolute differences (MAD) algorithm, a sum of absolute differences (SAD) algorithm, a sum of squared differences (SSD) algorithm, a mean square differences (MSD) algorithm, a normalized cross-correlation (NCC) algorithm, a sequential similarity detection algorithm (SSDA), a sum of absolute transformed difference (SATD) algorithm, or the like, or any combination thereof.

In some embodiments, using the template matching algorithm, the processing device 112 may search for the one or more areas of the image using a candidate window. The size of the candidate window may be the same as a specific target template image. The processing device 112 may search for the one or more areas of the image that match the specific target template image by sliding the candidate window in the image using the template matching algorithm. For each slide, the processing device 112 may determine a window similarity between an area of the image (e.g., a candidate window of a slide) and the specific template image. If the window similarity between the area of the image and the specific template image exceeds a window threshold, the processing device 112 may determine that the area matches the specific target template image. For the specific target template image, the processing device 112 may determine a matching coefficient between the image and the specific target template image based on the candidate window. The processing device 112 may determine the matching coefficient between the image and the specific target template image based on window similarities between the candidate window in multiple slides and the specific target template image. For example, the processing device 112 may rank the window similarities (e.g., in an ascending order or a descending order) and determine the window similarity with the maximum value as the matching coefficient. The processing device 112 may determine, based on the matching coefficient between the image and each of the one or more target template images, the detection result. For example, the processing device 112 may compare each matching coefficient between the image and each of the one or more target template images with a matching threshold. The matching threshold may be default settings of the O2O service system 100 or may be adjustable under different situations. For example, the matching threshold may be 85%, 90%, 95%, etc. In response to a determination that a matching coefficient exceeds the matching threshold, the processing device 112 may determine that the image is matched with one of the one or more target template images corresponding to the matching coefficient exceeding the matching threshold. Further, the processing device 112 may determine that the spot anomaly is detected in the image. As another example the processing device 112 may determine a maximum matching coefficient among multiple matching coefficients between the image and the one or more target template images. The processing device 112 may compare the maximum matching coefficient with the matching threshold. In response to a determination that the maximum matching coefficient is larger than the matching threshold, the processing device 112 may determine that the spot anomaly is detected in the image. In some embodiments, the processing device 112 may further determine whether the count or number of areas in the image matching the target template image corresponding to the matching coefficient exceeding the matching threshold. In response to a determination that the count or number of areas in the image matching the target template image corresponding to the matching coefficient exceeds the count threshold (e.g., 5, 10, 15, etc.), the processing device 112 may determine that the spot anomaly is detected in the image.

In 1408, in response to a determination that the detection result includes a spot anomaly, the processing device 112 (e.g., the generation module 430) may generate a strategy in response to the spot anomaly.

The strategy may include generating an alert for reminding a related personnel (e.g., a driver, a passenger, an engineer, a repair personnel, etc.) associated with the camera, informing a related personnel (e.g., a driver, a passenger, an engineer, a repair personnel, etc.) associated with the camera to examine and/or repair the camera, a suggestion for solving the spot anomaly, etc. In some embodiments, the processing device 112 may generate a signal including the strategy and detection result and transmit the signal to a terminal (e.g., a mobile terminal) associated with the related personnel. The signal may be also configured to direct the terminal to display the strategy and/or the detection result to the related personnel. For example, the signal may include the alert for reminding and/or informing the driver that the camera is blocked by one or more spots on the protective film of the windshield of the vehicle of the driver. As another example, the signal may include the suggestion for solving the spot anomaly, for example, advising the driver to clean the protective film of the windshield of the vehicle of the driver or the lens of the camera.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1400. In the storing operation, the processing device 112 may store the target template images, the matching coefficient, the detection result in any storage device (e.g., the storage device 160) disclosed elsewhere in the present disclosure.

FIG. 15 is a flowchart illustrating an exemplary process for determining one or more target template images according to some embodiments of the present disclosure. Process 1500 may be executed by the O2O service system 100. For example, the process 1500 may be implemented as a set of instructions (e.g., an application) stored in the storage 160, the ROM 230 or the RAM 240. The server 110, the processing device 112, the processor 220 and/or modules in FIG. 4 may execute the set of instructions, and when executing the instructions, the server 110, the processing device 112, the processor 220 and/or the modules may be configured to perform the process 1500. The operations of the illustrated process presented below are intended to be illustrative. In some embodiments, the process 1500 may be accomplished with one or more additional operations not described and/or without one or more of the operations discussed. Additionally, the order in which the operations of the process as illustrated in FIG. 15 and described below is not intended to be limiting. In some embodiments, one or more operations of the process 1500 may be performed to achieve at least part of operation 1402 as described in connection with FIG. 14.

In 1502, the processing device 112 (e.g., the acquisition module 402) may obtain a plurality of samples, each of the plurality of samples having a reference label indicating whether the each of the plurality of samples includes a spot anomaly. Each of the plurality of samples may include an image captured by a camera. The plurality of training samples may be obtained by the acquisition module 410 from a storage device (e.g., the storage device 160, the ROM 230, the RAM 240, the storage 390) or one or more cameras as described elsewhere in the present disclosure.

In some embodiments, the plurality of samples may be selected by a user manually. For example, the user may determine a plurality of images captured by one or more cameras. And the user may select a first portion of the plurality of images with the spot anomaly. The user may select a second portion of the plurality of images without the spot anomaly. The processing device 112 or the user may determine the reference label for each of the first portion of the plurality of images with the spot anomaly and the second portion of the plurality of images without the spot anomaly. For example, if an image includes the spot anomaly, the processing device 112 or the user may label the image with the reference label as a negative sample. If an image does not include the spot anomaly, the processing device 112 or the user may label the image with the reference label as a positive sample. As another example, if an image presents one or more spots and the count or number of the one or more spots exceeds a threshold (e.g., 10, 20, etc.), the user may label the image with the reference label as a negative sample. If an image presents no spots or the count or number of the one or more spots is smaller than the threshold (e.g., 10, 20, etc.), the user may label the image with the reference label as a positive sample. The first portion and/or the second portion of the plurality of images with reference labels may be designated as the plurality of samples.

In 1504, the processing device 112 (e.g., the evaluation module 414) may classify at least a portion of the plurality of samples into several groups, each of the at least a portion of the plurality of samples in the several groups presenting one or more spots. In some embodiments, each sample of the at least a portion of the plurality of samples may include the spot anomaly. Samples with similar spots may be classified into the same group. In some embodiments, the processing device 112 may classify the at least a portion of the plurality of samples based on characteristics of the one or more spots. For example, the processing device 112 may classify samples with spots having similar characteristics (e.g., similar shapes, similar sizes) into the same group. In some embodiments, the processing device 112 may detect and/or locate the one or more spots in a sample using a spot detection algorithm. The processing device 112 may determine image features (e.g., color features, texture features, spatial feature, etc.) related to the one or more spots from a sample using a feature extraction algorithm. The image features may denote the characteristics of the one or more spots. Exemplary spot detection algorithms may include a Gauss Laplacian operator detection (LOG) algorithm, a watershed algorithm, etc. Exemplary feature extraction algorithm may include a local binary patterns (LBP) algorithm, a histogram of oriented gradient (HOG) algorithm, scale-invariant features transform (SIFT) algorithm, a speeded up robust features (SURF) algorithm, a difference of Gaussian (DG) algorithm, or the like, or the combination thereof. The processing device 112 may classify samples into the same group based on similarity degrees between the image features extracted from the samples. For example, the processing device 112 may classify the samples from which the similarity degrees between the image features extracted exceeding a similarity threshold into the same group.

In 1506, the processing device 112 (e.g., the evaluation module 414) may determine a candidate template image from samples in each of the several groups. In some embodiments, the processing device 112 may select one sample from each of the several groups. The processing device 112 may segment the sample (i.e., an image) based on one or more detected spots to determine a part of the sample (i.e., an image) including the one or more detected spots. The segmented part of the sample (i.e., an image) may be designated as a candidate template image. In some embodiments, the processing device 112 may designate the selected sample as a candidate template image. In some embodiments, the processing device 112 may select multiple samples from one of the several groups. The processing device 112 may segment each of the multiple samples (i.e., an image) based on one or more detected spots to determine a part of each of the multiple samples (i.e., an image) including the one or more detected spots. The processing device 112 may average multiple parts of the multiple samples to obtain an average image. The average image may be designated as a candidate template image.

In 1508, the processing device 112 (e.g., the evaluation module 414) may evaluate, based on the plurality of samples, candidate template images corresponding to the several groups to determine an evaluating result of the candidate template images. In some embodiments, the processing device 112 may evaluate the candidate template images according to an evaluation index. The evaluating result may be denoted by a value of the evaluation index. The processing device 112 may determine the value of the evaluation index based on a detection result of each of the plurality of samples based on the candidate template images. For each of the plurality of samples, the processing device 112 may determine an estimated label of the sample based on the candidate template images. The estimated label of a sample may indicate whether the sample is a positive sample or a negative sample determined based on the candidate template images. The positive sample may indicate that the positive sample is normal, that is, the positive sample does not include the spot anomaly with respect to the candidate template images. The negative sample may indicate that the negative sample is anomalous, that is, the negative sample includes the spot anomaly with respect to the candidate template images. If a specific sample matches one of the candidate template images using a template matching algorithm, the processing device 112 may determine that the specific sample includes the spot anomaly and the estimated label of the specific sample may be a negative sample. If a specific sample does not match one of the candidate template images using the template matching algorithm, the processing device 112 may determine that the specific sample does not include the spot anomaly and the estimated label of the specific sample may be a positive sample. In some embodiments, the processing device 112 may determine the estimated label corresponding to a specific sample by comparing one of the candidate template images with the specific sample. For example, the processing device 112 may determine a similarity degree between one of the candidate template images and the specific sample. If the processing device 112 determines that the similarity degree between one of the candidate template images and the specific sample is greater than or equal to a threshold, the processing device 112 may determine the estimated label of the specific sample as a positive sample. If the processing device 112 determines that the similarity degree between the candidate template image and the sample is smaller than a threshold, the processing device 112 may determine the estimated label of the specific sample as a negative sample. In some embodiments, the processing device 112 may determine the similarity degree between one of the candidate template image and the specific sample based on a similarity degree between features related to one or more spots in one of the candidate template images and features related to one or more spots in the specific sample.

The processing device 112 may determine the value of the evaluation index of the candidate template images using the estimated label of each of the plurality of samples and the reference label of each of the plurality of samples. In some embodiments, the reference label of a sample may be also referred to as an actual label of the sample. For example, the user may determine a sample as a positive sample if the sample does not include the spot anomaly. The user may determine a sample as a negative sample if the sample includes the spot anomaly. In some embodiments, the evaluation index may be associated with a confusion matrix for the detection results of the plurality of samples determined using the candidate template images. The confusion matrix may be used to describe the performance of the candidate template images on predicting labels of the plurality of samples (e.g., determining an estimated label for each of the plurality of samples based on the candidate template images). The processing device 112 may determine the confusion matrix based on estimated labels of the plurality of samples and the reference labels of the plurality of samples. The processing device 112 may determine an evaluation index based on the confusion matrix. Exemplary evaluation indexes may include, for example, the accuracy, the recall as described elsewhere in the present disclosure (e.g., FIG. 13, and the descriptions thereof).

In 1510, the processing device 112 (e.g., the determination module 412) may determine, based on the evaluating result, target template images. In some embodiments, in response to a determination that the value of the evaluating result satisfies a condition, the processing device 112 may designate the candidate template images as the target template images. In response to a determination that the value of the evaluating result does not satisfy the condition, the processing device 112 may return to perform operation 1506 for adjusting the candidate template images form samples in the several groups and perform operations 1508 and 1510 until the evaluating result satisfies the condition.

In some embodiments, the processing device 112 may determine multiple sets of candidate template images. Each set of the multiple sets of candidate template images may include multiple samples each of which may be determined from one group of the several groups classified in operation 1504. The processing device 112 may determine an evaluating result for each set of the multiple sets of candidate template images to obtain multiple evaluating results according to operation 1508. The processing device 112 may determine one set of the multiple sets of candidate template images as the target template images. In some embodiments, the processing device 112 may compare the evaluating results corresponding to the multiple sets of the candidate template images. The processing device 112 may determine the target template images based on the comparison. The processing device 112 may compare the values of the evaluation indexes corresponding to the multiple sets of candidate template images. The processing device 112 may designate one set of the multiple sets of candidate template images that correspond to a maximum or minimum among the evaluation indexes as the target template images. As another example, the processing device 112 may determine at least two sets of the multiple sets of candidate template images. Values of evaluation indexes corresponding to the at least two sets of the multiple sets of candidate template images may be greater than values of evaluation indexes corresponding to other sets of candidate template images. The processing device 112 may designate an average of two corresponding samples in the at least two sets of candidate template images as one of the target template images. As used herein, the two corresponding samples in the at least two sets of candidate template images may refer to that the two corresponding samples are determined from a same group of the several groups of the plurality of samples.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1500. In the storing operation, the processing device 112 may store the candidate template image, the evaluating result, the target template image in any storage device (e.g., the storage device 160) disclosed elsewhere in the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “some embodiments,” and/or “some embodiments” mean that a particular feature, structure or characteristic described in connection with some embodiments is included in at least one embodiment of the present disclosure. Therefore, it is emphasized and should be appreciated that two or more references to “some embodiments,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer-readable media having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for image quality detection, comprising:
at least one storage medium including a set of instructions;
at least one processor in communication with the at least one storage medium, wherein when executing the set of instructions, the at least one processor is directed to cause the system to perform operations including:
obtaining an image acquired by a camera;
obtaining an image quality detection model, the image quality detection model being provided by training a machine learning model using a plurality of training samples;
determining a detection result of the image using the image quality detection model; and
in response to a determination that the detection result includes a quality anomaly of the image, generating a strategy in response to the quality anomaly.

2. The system of claim 1, wherein the quality anomaly of the image includes at least one of a blocking anomaly, a blur anomaly, an angle anomaly, a color cast anomaly, or a fill light anomaly.

3. The system of claim 2, wherein the image quality detection model is constructed based on a plurality of sub-models, each of at least a portion of the plurality of sub-models being configured to detect one of the blocking anomaly, the blur anomaly, the angle anomaly, the color cast anomaly, or the fill light anomaly.

4. The system of claim 1, wherein the image quality detection model is constructed based on at least one of a neural network model, a regression model, or a support vector machine.

5. The system of claim 1, wherein to determine the detection result of the image using the image quality detection model, the at least one processor is directed to cause the system to perform additional operations including:
extracting one or more features from the image; and
determining, based on the one or more features, the detection result using the image quality detection model.

6. The system of claim 5, wherein to extract one or more features from the image, the at least one processor is directed to cause the system to perform additional operations including:
marking a reference object in the image; and
extracting the one or more features associated with the reference object using the image quality detection model, wherein the determining, based on the one or more features, the detection result using the image quality detection model includes:
determining, based on the one or more features associated with the reference object, a relative location of the reference object in the image using the image quality detection model; and
determining, based on the relative location of the reference object in the image, the detection result.

7. The system of claim 6, wherein the reference object includes at least one of a skyline or a component of a vehicle installed with the camera, the component of the vehicle including at least one of an A-pillar, a B-pillar, or a neck pillow.

8. The system of claim 5, wherein to extract one or more features from the image, the at least one processor is directed to cause the system to perform additional operations including:
determining the one or more features associated with pixels in the image using the image quality detection model, wherein the determining, based on the one or more features, the detection result using the image quality detection model includes:
determining, based on the one or more features associated with the pixels in the image, the detection result using the image quality detection model.

9. The system of claim 8, wherein the one or more features associated with the pixels in the image include at least one of a gradient feature or a histogram feature.

10. The system of claim 1, wherein the image quality detection model is provided by operations including:
labeling each of the plurality of training samples with a reference label; and
training the machine learning model to obtain the image quality detection models using the plurality of training samples and the reference label corresponding to each of the plurality of training samples.

11. The system of claim 10, wherein the reference label indicates that the each of the plurality of training samples has a quality anomaly or a normal quality, and the training the machine learning model to obtain the image quality detection models includes:
extracting one or more features associated with pixels in the each of the labeled training samples; and
training the machine learning model to obtain the image quality detection models using the one or more features associated with pixels in the each of the labeled training samples and the reference label of the each of the plurality of training samples.

12. The system of claim 10, wherein the labeling each of the plurality of training samples with the reference label includes:
determining a location of a reference subject in each of the plurality of training samples; and
determining, based on the location of the reference subject in each of the plurality of training samples, the reference label, and wherein the training the machine learning model to obtain the image quality detection models using the labeled training samples includes:
inputting the each of the plurality of training samples and the corresponding reference label into the machine learning model to train the machine learning model.

13. The system of claim 1, wherein the plurality of training samples is provided by operations including:
obtaining one or more clear images;
performing a blur operation on the each of the one or more clear images to obtain a blurred image corresponding to each of the one or more clear images;
determining one or more features of the blurred image; and
designating the blurred image as one of at least a portion of the plurality of training samples in response to a determination that the one or more features of the blurred image satisfy a condition.

14. The system of claim 1, wherein the plurality of training samples are provided by operations including:
obtaining one or more second reference images;
converting each of the one or more second reference images from an RPG space into an HSV space;
determining one or more average features of the one or more second reference images in the HSV space; and
obtaining, based on the one or more average features, a plurality of candidate images;
determining one or more specific cameras whose light are in breakdown; and
obtaining at least a portion of the plurality of training samples from the one or more specific cameras.

15. The system of claim 1, wherein to determine the detection result of the image using the image quality detection model, the at least one processor is directed to cause the system to perform additional operations including:
determining a coincidence level corresponding to each of at least a portion of one or more quality anomalies using the image quality detection model; and
determining, based on the coincidence level corresponding to each of at least a portion of the one or more quality anomalies, the detection result.

16. A system for image quality detection, comprising:
at least one storage medium including a set of instructions;
at least one processor in communication with the at least one storage medium, wherein when executing the set of instructions, the at least one processor is directed to cause the system to perform operations including:
obtaining an image acquired by a camera;
determining, based on a target threshold of an image quality detection model, a detection result of the image using the image quality detection model;
in response to a determination that the detection result includes a color cast anomaly, generating a strategy in response to the color cast anomaly, wherein the target threshold is provided according to a process including:
obtaining a plurality of samples, each of at least a portion of the plurality of samples having a reference label indicating that each of the at least a portion of the plurality of samples having a color cast anomaly;
determining, based on the plurality of samples, the target threshold of the image quality detection model.

17. The system of claim 16, wherein to determine, based on the plurality of samples, the target threshold for image color cast detection, the at least one processor is directed to cause the system to perform additional operations including:
converting each of the plurality of samples from an RGB space into a LAB space;
determining an average chromaticity of each of the plurality of samples in the LAB space;
determining, based on the average chromaticity, a color cast factor of each of the plurality of samples; and
determining, based on the color cast factor of each of the plurality of samples, the target threshold.

18-21. (canceled)

22. A system for image quality detection, comprising:
at least one storage medium including a set of instructions;
at least one processor in communication with the at least one storage medium, wherein when executing the set of instructions, the at least one processor is directed to cause the system to perform operations including:
obtaining one or more target template images presenting one or more spots;
obtaining an image acquired by a camera;
determining, based on the one or more target template images, a detection result of the image; and
in response to a determination that the detection result includes a spot anomaly, generating a strategy in response to the spot anomaly.

23. The system of claim 22, wherein the one or more template images are provided by operations including:
obtaining a plurality of samples, each of the plurality of samples having a reference label indicating whether each of the plurality of samples includes the spot anomaly;
classifying at least a portion of the plurality of samples into several groups, each of the at least a portion of the plurality of samples in the several groups presenting the one or more spots;
determining a candidate template image from samples in each of the several groups to obtain multiple candidate template images;
evaluating, based on the plurality of samples, the multiple candidate template images to determine an evaluating result;
determining, based on the evaluating result, the one or more target template images.

24-26. (canceled)

27. The system of claim 22, wherein to determine, based on the one or more target template images, the detection result of the image, the at least one processor is further configured to direct the system to perform additional operations including:
determining the detection result of the image by performing a template matching algorithm between the each of the one or more target template images and the image.

28-34. (canceled)
